(19) United States
(12) Patent Application Publication
(10) Pub. No.: US 2021/0317795 A1
(43) Pub. Date: Oct. 14, 2021

(54) CONTROL DEVICE OF SUPERCHARGER-EQUIPPED ENGINE

(71) Applicant: AISAN KOGYO KABUSHIKI KAISHA, Obu-shi, Aichi (JP)

(72) Inventor: Takehide NAKAMURA, Nagoya-shi (JP)

(73) Assignee: AISAN KOGYO KABUSHIKI KAISHA, Obu-shi, Aichi (JP)

(21) Appl. No.: 17/256,894

(22) PCT Filed: Jun. 7, 2019
(86) PCT No.: PCT/JP2019/022737

§ 371 Date: Dec. 29, 2020

(30) Foreign Application Priority Data
Jul. 26, 2018 (JP) 2018-139883
Dec. 3, 2018 (JP) 2018-226566

(51) Int. Cl. F02D 41/00; F02M 26/14; F02B 37/16; F02D 41/22

(52) U.S. Cl. CPC F02D 41/0007; F02M 26/14; F02D 41/22; F02B 37/16; F02D 41/0077

(57) ABSTRACT

A throttle device is provided at the intake passage downstream of a compressor, a purge passage is connected to the intake passage upstream from the compressor, a purge valve is provided in the purge passage, an inlet valve is provided upstream of a connection position between the purge passage and the intake passage, and an air flow meter is provided in the intake passage upstream of the inlet valve. An electronic control device: calculates a target purge flow rate (TPFR) for vapor to the intake passage while the throttle device is controlled to a prescribed opening degree and the inlet valve is controlled to a target intake opening degree (TIOP); calculates the target purge opening degree to ensure the TPFR; controls the purge valve to the TIOP and corrects the TIOP by the TPFR; and controls the inlet valve by the corrected TIOP.

### TECHNICAL FIELD

The present invention relates to a control device of an engine equipped with a supercharger, i.e., a supercharger-equipped engine, and more particularly to a control device of a supercharger-equipped engine to flow a predetermined gas to an intake passage upstream from a compressor of the supercharger.

### BACKGROUND ART

As a conventional technique of the above type, for example, there has been known a technique described in for example Patent Document 1 listed below. This technique includes a low-pressure loop EGR device provided in an engine equipped with a supercharger. This EGR device includes: an EGR passage for allowing a part of exhaust gas discharged from the engine to an exhaust passage to flow as EGR gas into an intake passage upstream from a compressor of the supercharger; an EGR valve for regulating an EGR gas flow rate in the EGR passage; an inlet valve provided in the intake passage upstream from a junction of the EGR passage with the intake passage; a pressure sensor for detecting the pressure between the inlet valve and the EGR valve; and an electronic control device (ECU) for controlling the inlet valve based on the detected pressure so that a pressure difference occurs within a predetermined range between the upstream and downstream sides of the EGR valve. According to this device, the ECU controls the inlet valve based on the detected pressure so that a pressure difference is generated within a predetermined range between before and after the EGR valve. Thus, a desired pressure difference can be generated between before and after the EGR valve, thereby enabling stable supply of a required flow rate of EGR gas to the engine.

On the other hand, Patent document 2 listed below discloses an engine provided with an evaporated fuel treatment device. The device is configured to collect evaporated fuel (vapor) generated in a fuel tank into a canister, and purge the collected vapor to an intake passage through a purge passage. This intake passage is provided with a downstream throttle valve and an upstream throttle valve disposed upstream from the downstream throttle valve. An outlet of the purge passage is connected to a predetermined place between the upstream throttle valve and the downstream throttle valve. An opening degree of each of the upstream throttle valve and the downstream throttle valve is controlled to generate a predetermined negative pressure between those throttle valves. That is, this device is configured to purge the vapor from the purge passage to the intake passage by the pressure difference generated between before and after the purge valve and hence by the negative pressure generated on a downstream side of the upstream throttle valve (corresponding to the above-mentioned inlet valve).

### RELATED ART DOCUMENTS

### Patent Documents

Patent Document 1: Japanese unexamined patent application publication No. 2008-248729
Patent Document 2: Japanese unexamined patent application publication No. 10(1998)-274108

### SUMMARY OF INVENTION

### Problems to be Solved by the Invention

However, in the technique described in Patent Document 1, the inlet valve has somewhat opening-degree variation (including production variation within tolerance, and variation with time), so that the negative pressure acting on the outlet of the EGR passage is not stabilized (a deviation from a target negative pressure occurs) due to that opening-degree variation, leading to a possibility that the control accuracy of the EGR gas flow rate is deteriorated. In the technique of Patent Document 1, furthermore, the pressure sensor is used to control the inlet valve. This leads to an increase in cost and the pressure detection using the pressure sensor is likely to be affected by the EGR gas.

Herein, it is assumable to provide the evaporated fuel treatment device described in Patent Document 2 to the technique described in Patent Document 1 in addition to the EGR device or in place of the EGR device. In this case, the same problem as above may occur in the control accuracy of the purge flow rate from the purge passage to the intake passage. Further, the same problem may also occur even when a gas (for example, blow-by gas) other than the vapor is caused to flow in a similar manner to above into the intake passage.

The present disclosure has been made in view of the above circumstances and has an object to provide a control device of an engine with a supercharger, the control device being configured to accurately control a flow rate of a predetermined gas allowed to flow to an intake passage while enhancing the control accuracy of negative pressure by an inlet valve without using a dedicated pressure sensor regardless of opening-degree variation in the inlet valve.

### Means of Solving the Problems

(1) To achieve the above-mentioned purpose, one aspect of the present disclosure provides a control device of a supercharger-quipped engine, the engine comprising: a supercharger provided in an intake passage and an exhaust passage of the engine and configured to increase pressure of intake air in the intake passage, the supercharger including a compressor placed in the intake passage, a turbine placed in the exhaust passage, and a rotary shaft connecting the compressor and the turbine to cause the compressor and the turbine to integrally rotate; an intake amount regulating valve provided in the intake passage downstream from the compressor and configured to have an adjustable opening degree to regulate an intake amount of air flowing through the intake passage; a gas passage connected to the intake passage upstream from the compressor and configured to supply a predetermined gas to the intake passage; a gas flow regulating valve provided in the gas passage and configured to have an adjustable opening degree to regulate a gas flow rate in the gas passage; an inlet valve provided in the intake passage upstream from a junction of the gas passage with the intake passage and configured to have an adjustable opening degree to restrict the intake amount of air to be sucked in the intake passage; an intake flow detecting unit configured to detect the intake amount of air flowing through the intake passage upstream from the inlet valve; and a control unit configured to control at least the intake amount regulating valve, the gas flow regulating valve, and the inlet valve, wherein the control unit is configured to: while controlling the intake amount regulating valve to a predetermined opening degree and controlling the inlet valve to a target intake opening degree according to an operating state of the engine, calculate a target gas flow rate to be supplied to the intake passage according to the operating state of the engine; calculate a target gas flow rate opening degree for securing the target gas flow rate based on predetermined function data; control the gas flow regulating valve to the target gas flow rate opening degree; correct the target intake opening degree based on the target gas flow rate; and control the inlet valve based on the corrected target intake opening degree.

According to the above configuration (1), in a specific state where the intake amount regulating valve is controlled to the predetermined opening degree and also the inlet valve is controlled to the target intake opening degree, the target gas flow rate to be supplied from the gas passage to the intake passage is calculated. Further, the target gas flow rate opening degree for securing the target gas flow rate is calculated based on the predetermined function data. The gas flow regulating valve is controlled to the calculated target gas flow rate opening degree and also the target intake opening degree is corrected based on the target gas flow rate, and the inlet valve is controlled with the corrected target intake opening degree. Thus, the inlet valve is controlled to the target intake opening degree corrected based on the target gas flow rate, so that an actual intake pressure immediately downstream from the inlet valve is corrected according to the gas flow rate to be supplied.

(2) For achieving the foregoing purpose, in the configuration (1), the control unit is configured to: measure an actual gas flow rate to be supplied from the gas passage to the intake passage based on the intake amount detected by the intake flow detecting unit; calculate an opening degree correction value of the gas flow regulating valve or the inlet valve based on the measured actual gas flow rate so that the actual gas flow rate becomes equal to the target gas flow rate; and update the target gas flow rate opening degree in the function data based on the calculated opening degree correction value or update the target intake opening degree of the inlet valve.

According to the above configuration (2), in addition to the operations of the foregoing configuration (1), the actual gas flow rate supplied from the gas passage to the intake passage is measured; the opening degree correction value of the gas flow regulating valve or the inlet valve is calculated based on the actual gas flow rate so that the measured actual gas flow rate becomes equal to the target gas flow rate; and the target gas flow rate opening degree in the function data is updated based on the calculated opening degree correction value or the target intake opening degree of the inlet valve is updated. Thus, the target gas flow rate opening degree in the function data or the target intake opening degree is sequentially learnt to an optimum value.

(3) For achieving the foregoing purpose, in the configuration (1) or (2), there are further provided with: an EGR passage configured to allow a part of exhaust gas discharged from the engine to the exhaust passage to flow as EGR gas into the intake passage to return to the engine, the EGR passage including an inlet connected to the exhaust passage downstream from the turbine and an outlet connected to the intake passage upstream from the compressor and downstream from the inlet valve; and an EGR valve configured to have an adjustable opening degree to regulate an EGR gas flow rate in the EGR passage, wherein the control unit is configured to control at least the intake amount regulating valve, the gas flow regulating valve, the inlet valve, and the EGR valve, and the control unit is configured to: while controlling the intake amount regulating valve to the predetermined opening degree and controlling the inlet valve to the target intake opening degree according to the operating state of the engine, and further controlling the EGR valve to a target EGR opening degree according to the operating state of the engine, calculate the target gas flow rate to be supplied to the intake passage according to the operating state of the engine; calculate the target gas flow rate opening degree for securing the target gas flow rate based on the predetermined function data; control the gas flow regulating valve to the target gas flow rate opening degree; correct the target intake opening degree based on the target gas flow rate; and control the inlet valve based on the corrected target intake opening degree.

According to the above configuration (3), differently from the operations of the foregoing configuration (1) or (2), the following operations are obtained. Specifically, in a specific state where the intake amount regulating valve is controlled to the predetermined opening degree, the inlet valve is controlled to the target intake opening degree, and the EGR valve is controlled to the target EGR opening degree, the target gas flow rate opening degree to be supplied from the gas passage to the intake passage is calculated. Further, the target gas flow rate for securing the target gas flow rate is calculated based on the predetermined function data. The gas flow regulating valve is controlled to the calculated target gas flow rate opening degree, the target intake opening degree is corrected based on the target gas flow rate, and the inlet valve is controlled with the corrected target intake opening degree. Thus, the inlet valve is controlled to the target intake opening degree corrected based on the target gas flow rate, so that an actual intake pressure immediately downstream from the inlet valve is corrected according to the gas flow rate to be supplied.

(4) For achieving the foregoing purpose, in one of the configurations (1) to (3), the control unit is configured to: when controlling the gas flow regulating valve to fully close, controlling the inlet valve to fully open, and further controlling the intake amount regulating valve to an arbitrary controlled opening degree so that intake air passes through the intake amount regulating valve at sonic velocity, obtain an actual opening degree of the intake amount regulating valve based on the intake amount detected by the intake flow detecting unit and a predetermined basic expression; learn an opening degree correction value of the intake amount regulating valve from a difference between the obtained actual opening degree and the controlled opening degree; and correct control of the intake amount regulating valve based on the learnt opening degree correction value; and the control unit is configured to: after correcting the control of the intake amount regulating valve based on the learnt opening degree correction value of the intake amount regulating valve, when controlling the gas flow regulating valve to fully close and controlling the inlet valve to close to the arbitrary controlled opening degree, obtain an actual opening degree of the inlet valve based on the intake amount detected by the intake flow detecting unit and the basic expression; learn an opening degree correction value of the inlet valve from a difference between the obtained actual opening degree and the controlled opening degree of the inlet valve; and correct control of the inlet valve based on learnt opening degree correction value.

According to the above configuration (4), in addition to the operations of one of the foregoing configurations (1) to (3), the control of the intake amount regulating valve and the control of the inlet valve are corrected in the above manner. Accordingly, those controls of the intake amount regulating valve and the inlet valve are corrected without particularly using a dedicated pressure sensor for detecting the pressure downstream from the inlet valve. Thus, when the gas flow regulating valve is opened, the gas flow rate to be supplied from the gas passage to the intake passage is corrected regardless of the presence/absence of opening-degree variation of the inlet valve.

(5) For achieving the foregoing purpose, there is provided a control device of a supercharger-quipped engine, the engine comprising: a supercharger provided in an intake passage and an exhaust passage of the engine and configured to increase pressure of intake air in the intake passage, the supercharger including a compressor placed in the intake passage, a turbine placed in the exhaust passage, and a rotary shaft connecting the compressor and the turbine to cause the compressor and the turbine to integrally rotate; an intake amount regulating valve provided in the intake passage downstream from the compressor and configured to have an adjustable opening degree to regulate an intake amount of air flowing through the intake passage; an evaporated fuel treatment device configured to collect evaporated fuel generated in a fuel tank into a canister once and purge the evaporated fuel to the intake passage through a purge passage provided with a purge valve configured to have an adjustable opening degree, the purge passage including an inlet connected to the canister and an outlet connected to the intake passage upstream from the compressor; an inlet valve provided in the intake passage upstream from the outlet of the purge passage and configured to have an adjustable opening degree to restrict the intake amount of air to be sucked into the intake passage; an intake flow detecting unit configured to detect the intake amount of air flowing through the intake passage upstream from the inlet valve; and a control unit configured to control at least the intake amount regulating valve, the purge valve, and the inlet valve, wherein the control unit is configured to: when controlling the purge valve to fully close, controlling the inlet valve to fully open, and further controlling the intake amount regulating valve to an arbitrary controlled opening degree so that intake air passes through the intake amount regulating valve at sonic velocity, obtain an actual opening degree of the intake amount regulating valve based on the intake amount detected by the intake flow detecting unit and a predetermined basic expression; learn an opening degree correction value of the intake amount regulating valve from a difference between the obtained actual opening degree and the controlled opening degree; and correct control of the intake amount regulating valve based on the learnt opening degree correction value, and the control unit is configured to: after correcting the control of the intake amount regulating valve based on the learnt opening degree correction value of the intake amount regulating valve, when controlling the purge valve to fully close and controlling the inlet valve to close to the arbitrary controlled opening degree; obtain an actual opening degree of the inlet valve based on the intake amount detected by the intake flow detecting unit and the basic expression; learn an opening degree correction value of the inlet valve from a difference between the obtained actual opening degree and the controlled opening degree of the inlet valve; and correct control of the inlet valve based on the learnt opening degree correction value.

According to the above configuration (5), the control of the intake amount regulating valve and the control of the inlet valve are corrected in the above manner. Accordingly, those controls of the intake amount regulating valve and the inlet valve are corrected without particularly using a dedicated pressure sensor for detecting the pressure downstream from the inlet valve. Thus, when the purge valve is opened, the flow rate of evaporated fuel to be purged from the purge passage to the intake passage is corrected regardless of the presence/absence of opening-degree variation of the inlet valve.

(6) For achieving the foregoing purpose, in the configuration (4), the control unit is configured to: after correcting the control of the intake amount regulating valve based on the learnt opening degree correction value of the intake amount regulating valve and correcting the control of the inlet valve based on the learnt opening degree correction value of the inlet valve, obtain, as a gas flow rate change rate, a change rate of the intake amount detected by the intake flow detecting unit when the gas flow regulating valve is controlled to a predetermined second opening degree larger than a predetermined first opening degree, with respect to the intake amount detected by the intake flow detecting unit when the gas flow regulating valve is controlled to the first opening degree; obtain an actual opening degree of the gas flow regulating valve based on the gas flow rate change rate and the basic expression; learn an opening degree correction value of the gas flow regulating valve from a difference between the obtained actual opening degree and the second opening degree of the gas flow regulating valve; and correct control of the gas flow regulating valve based on the learnt opening degree correction value.

According to the above configuration (6), in addition to the operations of the foregoing configuration (4), the control of the gas flow regulating valve is corrected in the above manner. Accordingly, the control of the gas flow regulating valve is corrected without particularly using a dedicated pressure sensor for detecting the pressure downstream from the inlet valve. Thus, when the gas flow regulating valve is opened, the gas flow rate allowed to flow from the gas passage to the intake passage is corrected regardless of the presence/absence of opening-degree variation of the gas flow regulating valve.

(7) For achieving the foregoing purpose, in one of the configurations (4) to (6), the control unit is configured to compare the obtained actual opening degree of the inlet valve with a predetermined reference value for an opening degree of the inlet valve to diagnose abnormality of the inlet valve.

According to the above configuration (7), in addition to the operations of one of the foregoing configurations (4) to (6), the actual opening degree of the inlet valve is obtained based on the intake amount detected by the intake amount detecting unit when the intake amount regulating valve is controlled to the arbitrary controlled opening degree so that intake air passes through the intake amount regulating valve at sonic velocity, and abnormality of the inlet valve is diagnosed based on the obtained actual opening degree. Thus, there is no need to additionally provide a dedicated pressure sensor other than the intake amount detecting unit to diagnose the abnormality of the inlet valve.

(8) For achieving the foregoing purpose, in the configuration (6), the control unit is configured to compare the obtained actual opening degree of the gas flow regulating valve with a predetermined reference value for an opening degree of the gas flow regulating valve to diagnose abnormality of the gas flow regulating valve.

According to the above configuration (8), in addition to the operations of the foregoing configuration (6), the actual opening degree of the gas flow regulating valve is obtained based on the intake amount detected by the intake amount detecting unit when the intake amount regulating valve is controlled to the arbitrary controlled opening degree so that intake air passes through the intake amount regulating valve at sonic velocity, and abnormality of the gas flow regulating valve is diagnosed based on the obtained actual opening degree. Thus, there is no need to additionally provide a dedicated pressure sensor other than the intake amount detecting unit to diagnose the abnormality of the gas flow regulating valve.

(9) For achieving the foregoing purpose, in the configuration (2), the control unit is configured to compare the actual gas flow rate measured based on the intake amount detected by the intake flow detecting unit with a predetermined reference value to diagnose abnormality of the gas flow regulating valve or abnormality of the inlet valve.

According to the above configuration (9), in addition to the operations of the foregoing configuration (2), the abnormality of the gas flow regulating valve or the abnormality of the inlet valve is diagnosed based on the actual gas flow rate measured based on the intake amount detected by the intake amount detecting unit. Thus, there is no need to additionally provide a dedicated pressure sensor other than the intake amount detecting unit to diagnose the abnormality of the gas flow regulating valve or the abnormality of the inlet valve.

(10) For achieving the foregoing purpose, in the configuration (1), the control unit is configured to: measure an actual gas flow rate to be supplied from the gas passage to the intake passage based on the intake amount detected by the intake flow detecting unit; and compare the measured actual gas flow rate with a predetermined reference value to diagnose abnormality of the gas flow regulating valve or abnormality of the inlet valve.

According to the above configuration (10), in addition to the operations of the foregoing configuration (1), the abnormality of the gas flow regulating valve or the abnormality of the inlet valve is diagnosed based on the actual gas flow rate measured based on the intake amount detected by the intake amount detecting unit. Thus, there is no need to additionally provide a dedicated pressure sensor other than the intake amount detecting unit to diagnose the abnormality of the gas flow regulating valve or the abnormality of the inlet valve.

(11) For achieving the foregoing purpose, in one of the configurations (1) to (3), the control unit is configured to: when controlling the gas flow regulating valve to fully close, controlling the inlet valve to fully open, and further controlling the intake amount regulating valve to an arbitrary controlled opening degree so that intake air passes through the intake amount regulating valve at sonic velocity, obtain an actual opening degree of the intake amount regulating valve based on the intake amount detected by the intake flow detecting unit and a predetermined basic expression; learn an opening degree correction value of the intake amount regulating valve from a difference between the obtained actual opening degree and the controlled opening degree; and correct control of the intake amount regulating valve based on the learnt opening degree correction value; and the control unit is configured to: after correcting the control of the intake amount regulating valve based on the learnt opening degree correction value of the intake amount regulating valve, when controlling the gas flow regulating valve to fully close and controlling the inlet valve to close to the arbitrary controlled opening degree, obtain an actual opening degree of the inlet valve based on the intake amount detected by the intake flow detecting unit and the basic expression; and compare the obtained actual opening degree of the inlet valve with a predetermined reference value for the opening degree of the inlet valve to diagnose abnormality of the inlet valve.

According to the above configuration (11), in addition to the operations of one of the foregoing configurations (1) to (3), the actual opening degree of the inlet valve is obtained based on the intake amount detected by the intake amount detecting unit when the intake amount regulating valve is controlled to the arbitrary controlled opening degree so that intake air passes through the intake amount regulating valve at sonic velocity, and the abnormality of the inlet valve is diagnosed based on the obtained actual opening degree. Thus, there is no need to additionally provide a dedicated pressure sensor other than the intake amount detecting unit to diagnose the abnormality of the inlet valve.

(12) For achieving the foregoing purpose, in the configuration (4), the control unit is configured to: after correcting the control of the intake amount regulating valve based on the learnt opening degree correction value of the intake amount regulating valve and correcting the control of the inlet valve based on the learnt opening degree correction value of the inlet valve, obtain, as a gas flow rate change rate, a change rate of the intake amount detected by the intake flow detecting unit when the gas flow regulating valve is controlled to a predetermined second opening degree larger than a predetermined first opening degree, with respect to the intake amount detected by the intake flow detecting unit when the gas flow regulating valve is controlled to the first opening degree; obtain an actual opening degree of the gas flow regulating valve based on the gas flow rate change rate and the basic expression; and compare the obtained actual opening degree of the gas flow regulating valve with a predetermined reference value for the opening degree of the gas flow regulating valve to diagnose abnormality of the gas flow regulating valve.

According to the above configuration (12), in addition to the operations of the foregoing configuration (4), the actual opening degree of the gas flow regulating valve is obtained based on a change rate of the intake amount detected by the intake amount detecting unit when the intake amount regulating valve is controlled to the arbitrary controlled opening degree so that intake air passes through the intake amount regulating valve at sonic velocity, and the abnormality of the gas flow regulating valve is diagnosed based on the obtained actual opening degree. Thus, there is no need to additionally provide a dedicated pressure sensor other than the intake amount detecting unit to diagnose the abnormality of the gas flow regulating valve.

### Effects of the Invention

According to the foregoing configuration (1), it is possible to accurately control the predetermined gas flow rate allowed to flow to the intake passage while improving the control accuracy of intake negative pressure by the inlet valve without using a dedicated pressure sensor regardless of the opening-degree variation of the inlet valve.

According to the foregoing configuration (2), in addition to the effects of the above-mentioned configuration (1), it is possible to enhance the control accuracy of intake negative pressure by the inlet valve by eliminating production tolerance and variation with time of the inlet valve.

According to the foregoing configuration (3), it is possible to accurately control the predetermined gas flow rate and the EGR gas flow rate allowed to flow to the intake passage while enhancing the control accuracy of intake negative pressure by the inlet valve without using a dedicated pressure sensor regardless of opening-degree variation of the inlet valve.

According to the foregoing configuration (4), in addition to the effects of one of the above-mentioned configurations (1) to (3), it is possible to accurately control the gas flow rate to be supplied from the gas passage to the intake passage without using a dedicated pressure sensor regardless of the opening-degree variation of the inlet valve.

According to the foregoing configuration (5), it is possible to accurately control an amount of evaporated fuel to be purged from the purge passage to the intake passage without using a dedicated pressure sensor regardless of opening-degree variation of the inlet valve.

According to the foregoing configuration (6), in addition to the effects of the above-mentioned configuration (4), it is possible to accurately control the gas flow rate to be supplied from the gas passage to the intake passage without using a dedicated pressure sensor regardless of the opening-degree variation of the gas flow regulating valve.

According to the foregoing configuration (7), in addition to the effects of one of the above-mentioned configurations (4) to (6), it is possible to diagnose whether or not the inlet valve is abnormal, without using a dedicated pressure sensor.

According to the foregoing configuration (8), in addition to the effects of the above-mentioned configuration (6), it is possible to diagnose whether or not the gas flow regulating valve is abnormal, without using a dedicated pressure sensor.

According to the foregoing configuration (9), in addition to the effects of the above-mentioned configuration (2), it is possible to diagnose whether or not the gas flow regulating valve is abnormal or whether or not the inlet valve is abnormal, without using a dedicated pressure sensor.

According to the foregoing configuration (10), in addition to the effects of the above-mentioned configuration (1), it is possible to diagnose whether or not the gas flow regulating valve is abnormal or whether or not the inlet valve is abnormal, without using a dedicated pressure sensor.

According to the foregoing configuration (11), in addition to the effects of one of the above-mentioned configurations (1) to (3), it is possible to diagnose whether or not the inlet valve is abnormal, without using a dedicated pressure sensor.

According to the foregoing configuration (12), in addition to the effects of the above-mentioned configuration (4), it is possible to diagnose whether or not the gas flow regulating valve is abnormal, without using a dedicated pressure sensor.

### BRIEF DESCRIPTION OF THE DRAWINGS

FIG. 1 is a schematic diagram showing an engine system mounted in a vehicle in a first embodiment;

FIG. 2 is a flowchart showing contents of first opening-degree variation correction control in the first embodiment;

FIG. 3 is a graph showing changes in vehicle speed and integrated purge flow rate in the first embodiment;

FIG. 4 is a flowchart showing contents of second opening-degree variation correction control in a second embodiment;

FIG. 5 is a conceptual diagram showing each state of a throttle valve, an inlet valve, and a purge valve in the second embodiment;

FIG. 6 is a conceptual diagram showing a throttle opening degree map in the second embodiment;

FIG. 7 is a conceptual diagram showing each state of the throttle valve, the inlet valve, and the purge valve in the second embodiment;

FIG. 8 is a graph showing a relationship between a ratio of downstream pressure to upstream pressure of a certain valve and a flow coefficient in the second embodiment;

FIG. 9 is a conceptual diagram showing each state of the throttle valve, the inlet valve, and the purge valve in the second embodiment;

FIG. 10 is a table organized to show master opening degree, flow velocity, measurement item (intake amount), and specified items in relation to throttle opening degree correction, intake opening degree correction, and purge opening degree correction in the second embodiment;

FIG. 11 is a schematic diagram showing an engine system in a third embodiment;

FIG. 12 is a flowchart showing contents of third opening-degree variation correction control in the third embodiment;

FIG. 13 is a flow chart showing contents of fourth opening-degree variation correction control in a fourth embodiment;

FIG. 14 is a flow chart showing contents of the fourth opening-degree variation correction control in the fourth embodiment;

FIG. 15 is a conceptual diagram showing each state of a throttle valve, an inlet valve, a purge valve, and an EGR valve in the fourth embodiment;

FIG. 16 is a conceptual diagram showing each state of the throttle valve, the inlet valve, the purge valve, and the EGR valve in the fourth embodiment;

FIG. 17 is a conceptual diagram showing each state of the throttle valve, the inlet valve, the purge valve, and the EGR valve in the fourth embodiment;

FIG. 18 is a conceptual diagram showing each state of the throttle valve, the inlet valve, the purge valve, and the EGR valve in the fourth embodiment;

FIG. 19 is a table organized to show master opening degree, flow velocity, measurement item (intake amount), specified items in relation to throttle opening degree correction, intake opening degree correction, purge opening degree correction, and EGR opening degree correction in the fourth embodiment;

FIG. 20 is a flowchart showing contents of fifth opening-degree variation correction control in a fifth embodiment;

FIG. 21 is a flowchart showing the contents of the fifth opening-degree variation correction control in the fifth embodiment;

FIG. 22 is a flowchart showing contents of sixth opening-degree variation correction control in a sixth embodiment;

FIG. 23 is a flowchart showing the contents of the sixth opening-degree variation correction control in the sixth embodiment; and

FIG. 24 is a flowchart showing contents of seventh opening-degree variation correction control in a seventh embodiment.

### MODE FOR CARRYING OUT THE INVENTION

### First Embodiment

A detailed description of a first embodiment that embodies a control device of a supercharge-equipped engine in a gasoline engine system will now be given referring to the accompanying drawings.

(Outline of Engine System)

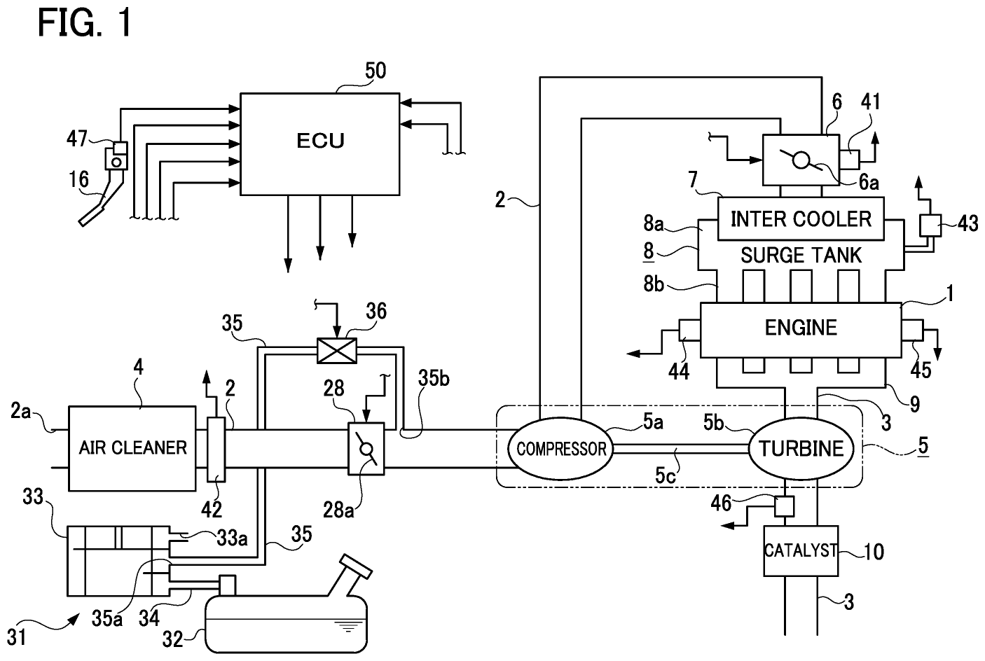

FIG. 1 is a conceptual diagram showing a gasoline engine system (hereinafter, simply referred to as “engine system”) mounted in a vehicle. This engine system includes an engine 1 having a plurality of cylinders. This engine 1 is a 4-cylinder, 4-cycle reciprocating engine, which includes well-known components, such as pistons and crankshafts. The engine 1 is provided with an intake passage 2 for introducing intake air to each cylinder and an exhaust passage 3 for discharging exhaust gas from each cylinder of the engine 1. In the intake passage 2 and the exhaust passage 3, a supercharger 5 is provided. In the intake passage 2, there are provided, from an upstream side, an intake inlet 2a, an air cleaner 4, a compressor 5a of the supercharger 5, an electronic throttle device 6, an intercooler 7, and an intake manifold 8 in this order.

The electronic throttle device 6 is provided in the intake passage 2 downstream from the compressor 5a and configured to have an opening degree that can be adjusted when the electronic throttle device 6 is driven to open and close in response to an operation of an accelerator pedal 16 by a driver in order to regulate an intake amount of air flowing through the intake passage 2. In this embodiment, the electronic throttle device 6 is constituted of a DC-motor electrically-operated valve and includes a throttle valve 6a to be driven to open and close and a throttle sensor 41 for detecting an opening degree TA of the throttle valve 6a (a throttle opening degree). The electronic throttle device 6 corresponds to one example of an intake amount regulating valve in the present disclosure. The intake manifold 8 is placed immediately upstream from the engine 1 and includes a surge tank 8a in which intake air is introduced and a plurality of (four) branch pipes 8b for distributing the intake air introduced in the surge tank 8 to each cylinder of the engine 1. In the exhaust passage 3, there are provided, from an upstream side, an exhaust manifold 9, a turbine 5b of the supercharger 5, and a catalyst 10 in this order. The catalyst 10 functions to purify exhaust gas and may be constituted of e.g. three-way catalyst.

The supercharger 5 is provided to increase the pressure of intake air in the intake passage 2 and includes the compressor 5a placed in the intake passage 2, the turbine 5b placed in the exhaust passage 3, and a rotary shaft 5c connecting the compressor 5a and the turbine 5b to cause the compressor 5a and the turbine 5b to integrally rotate. When the turbine 5b is rotated by the exhaust gas flowing through the exhaust passage 3 and the compressor 5a is rotated in sync with the turbine 5b, the pressure of intake air flowing through the intake passage 2 is increased. The intercooler 7 functions to cool the intake air whose pressure has been increased by the compressor 5a.

The engine 1 is provided with a fuel injection device (not shown) to inject fuel in correspondence with each cylinder. The fuel injection device is configured to inject fuel supplied from a fuel supply device (not shown) into each cylinder of the engine 1. In each cylinder, the fuel injected from the fuel injection device and the intake air introduced from the intake manifold 8 form a combustible air-fuel mixture.

The engine 1 is further provided with an ignition device (not shown) in correspondence with each cylinder. The ignition device is configured to ignite the combustible air-fuel mixture generated in each cylinder. The combustible air-fuel mixture in each cylinder is exploded and burnt by an igniting action of the ignition device. The exhaust gas after burning is discharged to the outside through each cylinder, the exhaust manifold 9, the turbine 5b, and the catalyst 10. At that time, a piston (not shown) in each cylinder moves up and down, thereby rotating a crankshaft (not shown), generating power in the engine 1.

(Evaporated Fuel Treatment Device)

The engine system in the present embodiment is provided with an evaporated fuel treatment device 31. This device 31 is a device for treatment to collect evaporated fuel (vapor) generated in a fuel tank 32 without releasing the vapor to the atmosphere. This device 31 includes a canister 33, a vapor passage 34, a purge passage 35, and a purge valve 36. The canister 33 collects once the vapor generated in the fuel tank 32 through the vapor passage 34. The canister 33 contains an adsorbent (not shown) that adsorbs the vapor. In the present embodiment, the purge passage 35 is connected to the intake passage 2 upstream from the compressor 5a to supply the vapor as a predetermined gas to the intake passage 2. The purge passage 35 corresponds to one example of a gas passage in the present disclosure. The purge passage 35 has an inlet 35a connected to the canister 33 and an outlet 35b connected to the intake passage 2 upstream from the compressor 5a. In the purge passage 35, there is provided the purge valve 36 configured to have an adjustable opening degree to regulate a purge flow rate of vapor as a gas flow rate in the purge passage 35. The purge valve 36 corresponds to one example of a gas flow regulating valve in the present disclosure. The purge valve 36 is configured so that its opening degree can be adjusted by an electrically-operated valve to regulate the purge flow rate in the purge passage 35. An atmosphere port 33a provided in the canister 33 serves to introduce atmospheric air into the canister 33 when the vapor is to be purged from the canister 33.

(Intake Valve)

The engine system in the present embodiment is provided with an inlet valve 28. The inlet valve 28 is placed in the intake passage 2 downstream from the air cleaner 4 and upstream from a junction (the outlet 35b) of the purge passage 35 connected with the intake passage 2. The inlet valve 28 is configured to have an adjustable opening degree to restrict the intake amount of air to be sucked in the intake passage 2. In the present embodiment, the inlet valve 28 is constituted of an electrically-operated valve using a DC motor and includes a butterfly valve 28a whose opening degree is adjustable. When the vapor is purged into the intake passage 2 through the outlet 35b of the purge passage 35, the inlet valve 28 is configured to restrict the opening degree of the butterfly valve 28a in order to make the intake pressure near the outlet 35b negative.

(Electrical Configuration of Engine System)

As shown in FIG. 1, various sensors and others 41 to 47 provided in this engine system correspond to one example of an operating state detecting unit for detecting an operating state of the engine 1. An air flow meter 42 provided near the air cleaner 4 is located upstream from the inlet valve 28 and configured to detect an intake amount Ga of air flowing from the air cleaner 4 to the intake passage 2 and output an electrical signal representing a detection value. The air flow meter 42 corresponds to one example of an intake amount detecting unit in the present disclosure. An intake pressure sensor 43 provided in the surge tank 8a is configured to detect an intake pressure PM downstream from the electronic throttle device 6 and output an electrical signal representing a detection value. A water temperature sensor 44 provided in the engine 1 is configured to detect a temperature THW of coolant water flowing through the inside of the engine 1 (cooling water temperature) and output an electrical signal representing a detection value. A rotation speed sensor 45 provided in the engine 1 is configured to detect the rotation speed of the crank shaft as a rotation speed NE of the engine 1 (engine rotation speed) and output an electrical signal representing a detection value. An oxygen sensor 46 provided in the exhaust passage 33 downstream from the turbine 5b is configured to detect an oxygen concentration (output voltage) Ox of the exhaust gas discharged to the exhaust passage 3 and output an electrical signal representing a detection value. The accelerator pedal 16 provided on a driver's seat side is provided with an accelerator sensor 47. The accelerator sensor 47 is configured to detect a depression angle of the accelerator pedal 16 as an accelerator opening degree ACC and output an electrical signal representing a detection value.

The above-described engine system is further provided with an electronic control unit (ECU) 50 configured to perform various controls. This ECU 50 is connected to each of the various sensors and others 41 to 47. The ECU 50 is also connected to each of the electronic throttle device 6, the EGR valve 23, the inlet valve 28, the purge valve 36, and others.

In the present embodiment, the ECU 50 is configured to receive various signals outputted from the various sensors and others 41 to 47 and, based on those signals, control the fuel injection device and the ignition device respectively to perform fuel injection control and ignition timing control. The ECU 50 is further configured to control each of the electronic throttle device 6, the inlet valve 28, and the purge valve 36 to perform intake control and purge control based on various signals.

Herein, the intake control is to control the electronic throttle device 6 based on a detection value of the accelerator sensor 47 according to an operation of the accelerator pedal 16 by a driver in order to control the intake amount of air to be introduced in the engine 1. The ECU 50 is configured to control the electronic throttle device 6 in a valve closing direction in order to restrict the intake amount of air allowed to flow to the engine 1 during deceleration of the engine 1.

The purge control is to mainly control the purge valve 36 and the inlet valve 28 according to the operating state of the engine 1 to control a purge flow rate of the vapor to be supplied (purged) from the purge passage 35 to the intake passage 2. During operation of the engine 1, the ECU 50 closes (narrows) the inlet valve 28 and controls the purge valve 36 to a required opening degree. This generates a negative intake pressure near the outlet 35b of the purge passage 35, thereby purging the gas containing the vapor trapped in the canister 33 from the purge passage 35 to the intake passage 2. The vapor purged into the intake passage 2 is sucked and burnt in the engine 1 and processed.

The ECU 50 is provided, as well known, with a central processing unit (CPU), various memories, an external input circuit and an external output circuit, and others. The memories store predetermined control programs for various controls of the engine 1. The CPU is configured to execute various controls mentioned above according to the predetermined control programs based on detection values of the various sensors and others 41 to 47 inputted through the input circuit. The ECU 50 corresponds to one example of a control unit in the present disclosure.

(First Opening-Degree Variation Correction Control)

Herein, the above-mentioned electronic throttle device 6, inlet valve 28, and purge valve 36 have some variations in opening degree (including production variation within tolerance and variation with time). Further, depending on the opening-degree variation of the inlet valve 28, the negative pressure acting on the outlet 35b of the purge passage 35 may deviate from a target value. Moreover, depending on the opening-degree variation of the purge valve 36, the purge flow rate of purge gas allowed to flow from the purge passage 35 to the intake passage 2 may deviate from a target value, leading to deterioration in control accuracy of the purge flow rate during execution of the purge control. In this embodiment, therefore, in order to enhance the control accuracy of the purge flow rate while improving the control accuracy of the intake pressure (the negative pressure) by the inlet valve 28 regardless of the opening-degree variation of the inlet valve 28, the ECU 50 is configured to execute the first control to correct opening-degree variations (“first opening-degree variation correction control”) as described below.

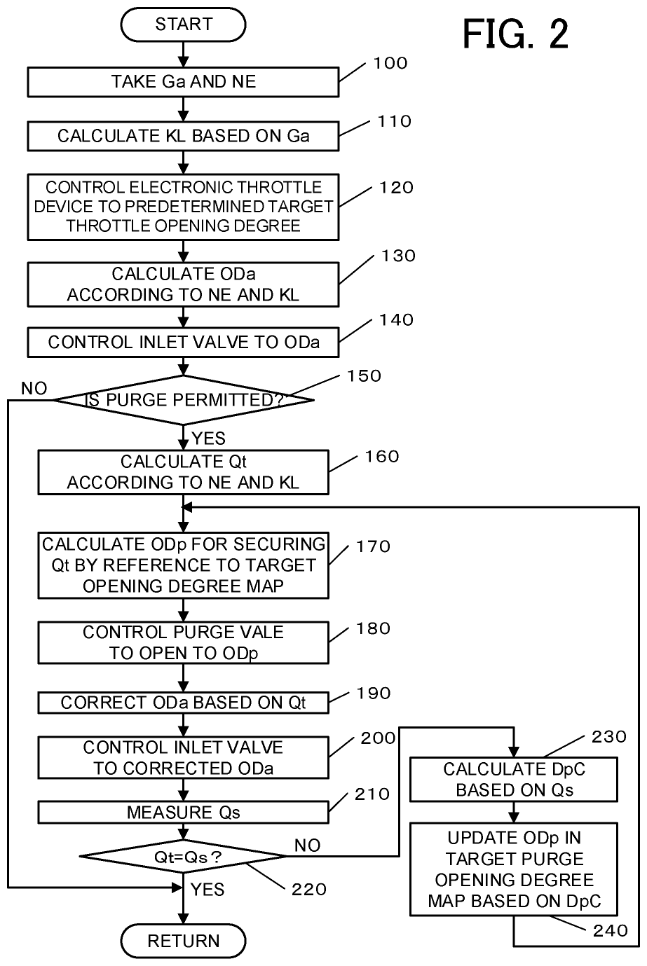

FIG. 2 is a flowchart showing contents of the first opening-degree variation correction control. When the processing is shifted to this routine, in step 100, the ECU 50 takes an intake amount Ga and an engine rotation speed NE from detection values of the air flow meter 42 and the rotation speed sensor 45 respectively.

In step 110, the ECU 50 then calculates an engine load KL from the intake amount Ga. The ECU 50 can obtain the engine load KL from the intake amount Ga by reference to for example a predetermined function expression or a function map.

In step 120, the ECU 50 successively controls the electronic throttle device 6 to a predetermined target throttle opening degree. This target throttle opening degree is a predetermined opening degree set for subsequent processings.

In step 130, the ECU 50 calculates a target intake opening degree ODa for the inlet valve 28 according to the taken engine rotation speed NE and engine load KL by reference to a predetermined function map.

In step 140, the ECU 50 controls the inlet valve 28 to the calculated target intake opening degree ODa.

In step 150, the ECU 50 determines whether or not purge is permitted.

Specifically, the ECU 50 determines whether or not the engine 1 is in an operating state in which the purge can be permitted. When this determination result is affirmative, the ECU 50 shifts the processing to step 160. When this determination result is negative, the ECU 50 returns the processing to step 100.

In step 160, the ECU 50 calculates a target purge flow rate Qt on the basis of the engine rotation speed NE and the engine load KL. The target purge flow rate Qt corresponds to one example of a target gas flow rate in the present disclosure.

In step 170, the ECU 50 calculates a target purge opening degree ODp for the purge valve 36 to secure the target purge flow rate Qt by reference to a predetermined “target purge opening degree map”.

In step 180, the ECU 50 then controls the purge valve 36 to open to the target purge opening degree ODp.

In step 190, the ECU 50 corrects the target intake opening degree ODa based on the target purge flow rate Qt. The ECU 50 can correct this target intake opening degree ODa based on the target purge flow rate Qt by reference to a predetermined function map.

In step 200, the ECU 50 controls the inlet valve 28 to a corrected target intake opening degree ODa.

In step 210, the ECU 50 measures an actual purge flow rate Qs. The ECU 50 can measure this actual purge flow rate Qs based on the intake amount Ga detected by the air flow meter 42. In other words, the ECU 50 can obtain the actual purge flow rate Qs from a difference between an intake amount Ga under non-purging and an intake amount Ga under purging. The actual purge flow rate corresponds to one example of an actual gas flow rate in the present disclosure.

In step 220, the ECU 50 determines whether or not the target purge flow rate Qt and the actual purge flow rate Qs are equal to each other. When this determination result is affirmative, the ECU 50 returns the processing to step 100. When this determination result is negative, the ECU 50 shifts the processing to step 230.

In step 230, the ECU 50 calculates a purge opening degree correction value DpC based on the actual purge flow rate Qs. The ECU 50 can obtain this purge opening degree correction value DpC according to the actual purge flow rate Qs by reference to a predetermined function expression or map.

In step 240, the ECU 50 updates the target purge opening degree ODp in the “target purge opening degree map” based on the purge opening degree correction value DpC. Then, the ECU 50 returns the processing to step 170.

According to the foregoing first opening-degree variation correction control, the ECU 50 (the control unit) controls the electronic throttle device 6 (the intake amount regulating valve) to the target throttle opening degree (the predetermined opening degree) and also controls the inlet valve 28 to the target intake opening degree ODa according to the engine rotation speed NE and the engine load KL (the operating state of the engine 1). While controlling the electronic throttle device 6 and the inlet valve 28, the ECU 50 is configured to: calculate the target purge flow rate Qt (the target gas flow rate) to be purged (supplied) to the intake passage 2 according to the engine rotation speed NE and the engine load KL (the operating state of the engine 1); calculate the target purge opening degree ODp (the target gas flow rate opening degree) for securing the target purge flow rate Qt based on the predetermined target purge opening degree map (function data); control the purge valve 36 (the gas flow regulating valve) to the target purge opening degree ODp; correct the target intake opening degree ODa based on the target purge flow rate Qt; and control the inlet valve 28 based on the corrected target intake opening degree ODa. This configuration corresponds to the technique recited in claim 1 of the present application.

According to the foregoing first opening-degree variation correction control, the ECU 50 is further configured to: measure the actual purge flow rate Qs (the actual gas flow rate) supplied from the purge passage 35 (the gas passage) to the intake passage 2 based on the intake amount Ga detected by the air flow meter 42 (the intake amount detecting unit); calculate the purge opening degree correction value DpC (the opening degree correction value of the gas flow regulating valve) based on the measured actual purge flow rate Qs so that the actual purge flow rate Qs becomes equal to the target purge flow rate Qt (the target gas flow rate); and update the target purge opening degree (the target gas flow rate opening degree) in the target purge opening degree map (function data) based on the calculated purge opening degree correction value DpC. This configuration corresponds to the technique recited in claim 2 of the present application.

According to the control device of a supercharger-equipped engine in the present embodiment described above, the ECU 50 executes the foregoing first opening-degree variation correction control during operation of the engine 1. According to this correction control, in a specific state where the electronic throttle device 6 is controlled to the predetermined throttle opening degree and also the inlet valve 28 is controlled to the target intake opening degree, the target purge flow rate Qt to be supplied from the purge passage 35 to the intake passage 2 is calculated. Furthermore, the target purge opening degree ODp for securing the target purge flow rate Qt is calculated based on the predetermined target purge opening degree map. Thus, the purge valve 36 is controlled to the calculated target purge opening degree ODp, and also the target intake opening degree ODa is corrected based on the target purge flow rate Qt and the inlet valve 28 is controlled based on the corrected target intake opening degree ODa. Accordingly, the inlet valve 28 is controlled to the target intake opening degree ODa corrected based on the target purge flow rate Qt, so that the actual intake pressure immediately downstream from the inlet valve 28 is corrected according to a purge flow rate to be supplied. Consequently, while enhancing the control accuracy of the intake negative pressure by the inlet valve 28 without using a dedicated pressure sensor, regardless of variation in opening degree of the inlet valve 28, the ECU 50 can accurately control the purge flow rate of purge gas allowed to flow in the intake passage 2.

According to the foregoing correction control, the actual purge flow rate Qs to be purged from the purge passage 35 to the intake passage 2 is measured, the purge opening degree correction value DpC is calculated based on the measured actual purge flow rate Qs so that the purge flow rate Qs becomes equal to the target purge flow rate Qt, and the target purge opening degree ODp in the target purge opening degree map is updated based on the calculated purge opening degree correction value DpC. Accordingly, the target purge opening degree ODp in the target purge opening degree map is sequentially leant to an optimum value. Consequently, the control device can enhance the control accuracy of intake negative pressure by the inlet valve 28 by eliminating production tolerance and variation with time of the inlet valve 28.

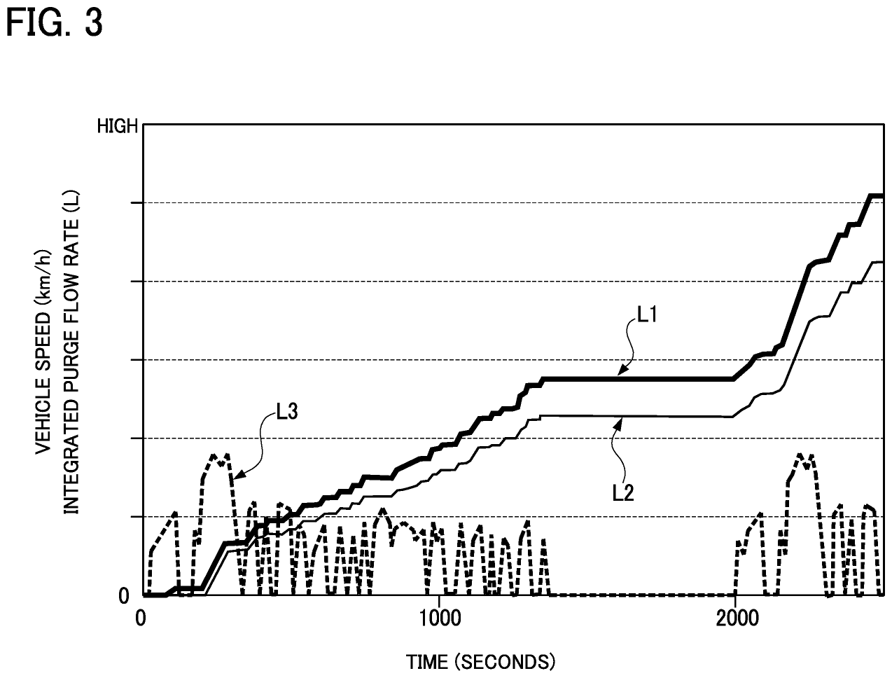

FIG. 3 is a graph showing changes in vehicle speed and integrated purge flow rate (integrated value of purge flow rate). In this graph, a thick line L1 indicates changes in integrated purge flow rate in the present embodiment that executes the first opening-degree variation correction control, a solid line L2 indicates changes in integrated purge flow rate in a comparative example that does not execute the same correction control, and a broken line L3 indicates changes in vehicle speed. As shown in this graph, it is revealed in the present embodiment that the integrated purge flow rate is increased by enhancement of the control accuracy of the purge flow rate of vapor as compared with the comparative example.

### Second Embodiment

Next, a second embodiment that embodies the control device of a supercharger-equipped engine in a gasoline engine system will be described in detail with reference to accompanying drawings.

In the following description, similar or identical components to those in the first embodiment are assigned the same reference signs and their details are omitted. The following description will be made with a focus on differences from the first embodiment. The second embodiment differs from the first embodiment in contents of the opening-degree variation correction control.

(Second Opening-Degree Variation Correction Control)

In the engine system shown in FIG. 1, the electronic throttle device 6, the inlet valve 28, and the purge valve 36 have some opening-degree variations (including production variation within tolerance and variation with time). Further, depending on the opening-degree variation of the inlet valve 28, the intake pressure (the negative pressure) acting on the outlet 35b of the purge passage 35 may deviate from a target value. Moreover, depending on the opening-degree variation of the purge valve 36, the purge flow rate that flows from the purge passage 35 to the intake passage 2 may deviate from a target value, leading to deterioration in control accuracy of the purge flow rate during execution of the purge control. In this embodiment, therefore, for the purpose of enhancing the control accuracy of the purge flow rate regardless of the opening-degree variation of the inlet valve 28 and the opening-degree variation of the purge valve 36, the ECU 50 is configured to execute the second control to correct opening-degree variations (“second opening-degree variation correction control”) as described below.

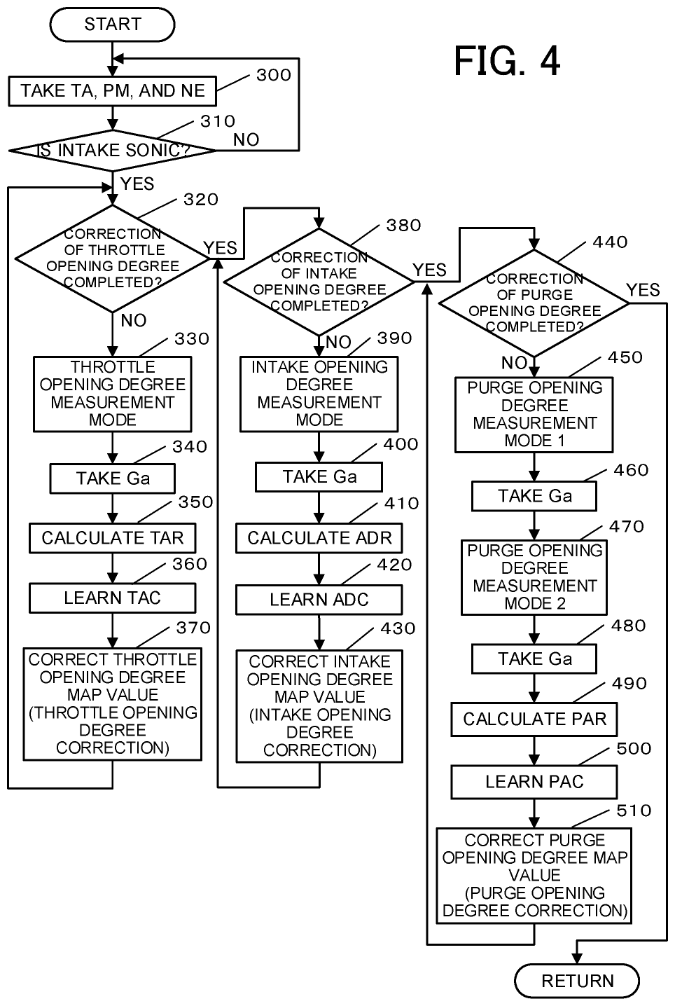

FIG. 4 is a flowchart showing contents of the second opening-degree variation correction control. When the processing is shifted to this routine, in step 300, the ECU 50 takes a throttle opening degree TA, an intake pressure PM, and an engine rotation speed NE from detection values of the throttle sensor 41, the intake pressure sensor 43, and the rotation speed sensor 45 respectively.

In step 310, successively, the ECU 50 determines whether or not the velocity of intake air passing through the electronic throttle device 6 is sonic, that is, whether or not the intake air passes through the throttle valve 6a at sonic velocity. The condition that the velocity of intake air is sonic may include for example a condition that fuel supply to the engine 1 is shut off during deceleration of the engine 1 (i.e., during deceleration fuel-cut). The ECU 50 can make this determination based on the intake pressure PM. When this determination result is negative, the ECU 50 returns the processing to step 300. When this determination result is affirmative, the ECU 50 shifts the processing to step 320.

In step 320, the ECU 50 determines whether or not throttle opening degree correction for the electronic throttle device 6 has been completed. When this determination result is negative, the ECU 50 shifts the processing to step 330. When this determination result is affirmative, the ECU 50 shifts the processing to step 380.

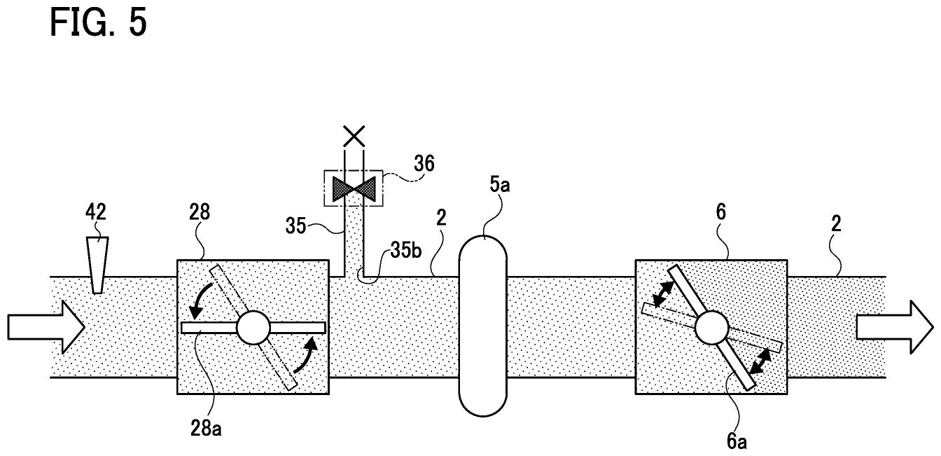

In step 330, the ECU 50 executes the processing of a throttle opening degree measurement mode for the electronic throttle device 6. FIG. 5 is a conceptual diagram showing each state of the electronic throttle device 6, the inlet valve 28, and the purge valve 36 at that time. Specifically, as shown in FIG. 5, the ECU 50 sets a master opening degree of the electronic throttle device 6 to a predetermined value (e.g., 7 deg), sets a master opening degree of the inlet valve 28 to full open (90 deg), and sets a master opening degree of the purge valve 36 to full close (0%). At that time, the intake air passes through the electronic throttle device 6 (the throttle valve 6a) at sonic velocity and thus the pressure upstream from the electronic throttle device 6 is substantially an atmospheric pressure (known).

In step 340, the ECU 50 takes the intake amount Ga based on a detection value of the air flow meter 42. Herein, since the velocity of the intake air passing through the electronic throttle device 6 is sonic, the intake amount Ga detected by the air flow meter 42 indicates a constant value which is steady even if the engine rotation speed NE somewhat changes.

In step 350, the ECU 50 then calculates a real opening degree (an actual opening degree) of the electronic throttle device 6, that is, a throttle actual opening degree TAR, based on the detected intake amount Ga and the following basic expression (F) representing a flow rate of intake air passing through a valve (i.e., a valve passing flow rate):

dm=A·Cq·Cm·Pub/√Tup (F).

In this step 350, in the basic expression (F), “dm” denotes the intake amount Ga (a mass flow rate) and is known, “A” indicates an opening area of the throttle valve 6a and has production variation, “Cq” denotes a flow rate coefficient of the throttle valve 6a and is known, “Cm” denotes a flow coefficient of the throttle valve 6A and is known in a sonic velocity range, “Pup” denotes the pressure on an upstream side of the throttle valve 6a, corresponding to atmospheric pressure, and is known, and “Tup” denotes the temperature on the upstream side of the throttle valve 6a, corresponding to an atmospheric temperature, and is known. Thus, the opening area A when the electronic throttle device 6 is set to a predetermined master opening degree can be specified by the basic expression (F) from a relationship between the intake amount Ga (dm) and the sonic velocity range. From this opening area A, the throttle actual opening degree TAR can be obtained. Herein, since the velocity of intake air is sonic, the opening area A can be accurately acquired, so that the throttle actual opening degree TAR can be accurately obtained.

In step 360, the ECU 50 leans a throttle opening degree correction value TAC. Specifically, the ECU 50 obtains the throttle opening degree correction value TAC based on a difference between the throttle actual opening degree TAR and the master opening degree of the electronic throttle device 6, and stores it in a memory.

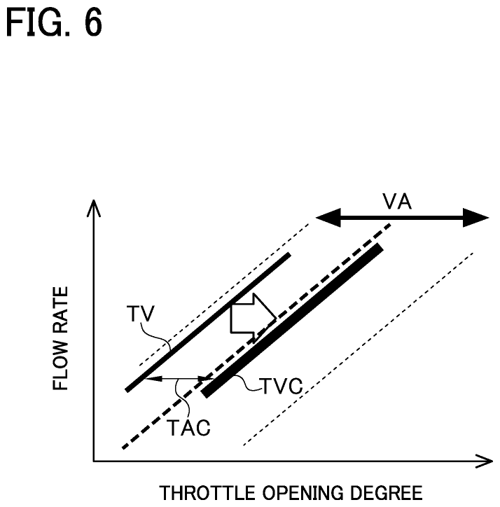

In step 370, the ECU 50 then corrects a throttle opening degree map value (throttle opening degree correction). Specifically, the ECU 50 corrects a predetermined throttle opening degree map value with the throttle opening degree correction value TAC. FIG. 6 is a conceptual diagram showing the throttle opening degree map. As shown in FIG. 6, a relationship of the flow rate to the throttle opening degree generally includes production variation VA. Herein, for example, the ECU 50 can obtain a corrected target value TVC (the throttle opening degree map value) by subtracting the throttle opening degree correction value TAC from an uncorrected target value TV (the throttle opening degree map value). This correction of the throttle opening degree map value can eliminate opening-degree variation due to production tolerance and variation with time of the electronic throttle device 6.

After completion of the throttle opening degree correction in step 370, the processing is shifted from step 320 to step 380, in which the ECU 50 determines whether or not intake opening degree correction for the inlet valve 28 has been completed. When this determination result is negative, the ECU 50 shifts the processing to step 390. When this determination result is affirmative, the ECU 50 shifts the processing to step 440.

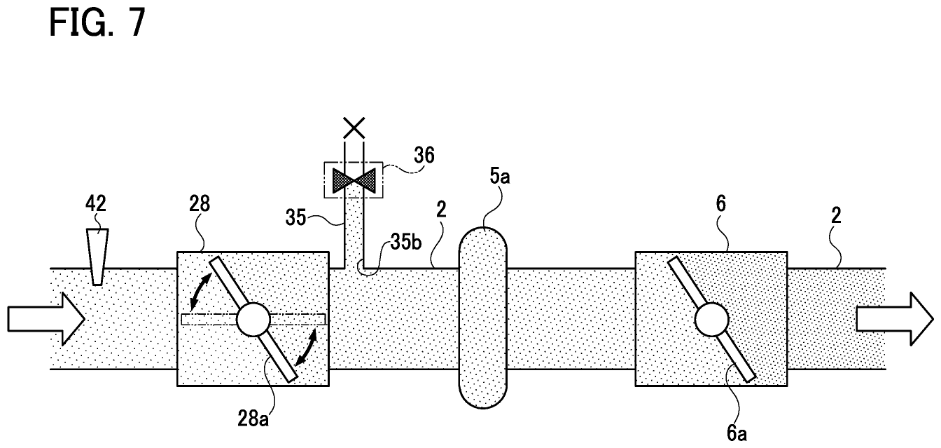

In step 390, the ECU 50 executes the processing of an intake opening degree measurement mode for the inlet valve 28. FIG. 7 is a conceptual diagram showing each state of the electronic throttle device 6, the inlet valve 28, and the purge valve 36 at that time. Specifically, as shown in FIG. 7, the ECU 50 sets the corrected opening degree of the electronic throttle device 6 to a predetermined value (e.g., equivalent to 7 deg), sets the master opening degree of the inlet valve 28 to a predetermined value (e.g., 6 deg) to close the inlet valve 28 from a fully open position, and sets the master opening degree of the purge valve 36 to full close (0%). At that time, the intake air passes through the electronic throttle device 6 (the throttle valve 6a) at sonic velocity and the pressure on an upstream side of the inlet valve 28 is an atmospheric pressure (known).

In step 400, the ECU 50 takes the intake amount Ga based on a detection value of the air flow meter 42. Herein, since the velocity of the take air passing through the electronic throttle device 6 is sonic, the intake amount Ga detected by the air flow meter 42 indicates a steady constant value.

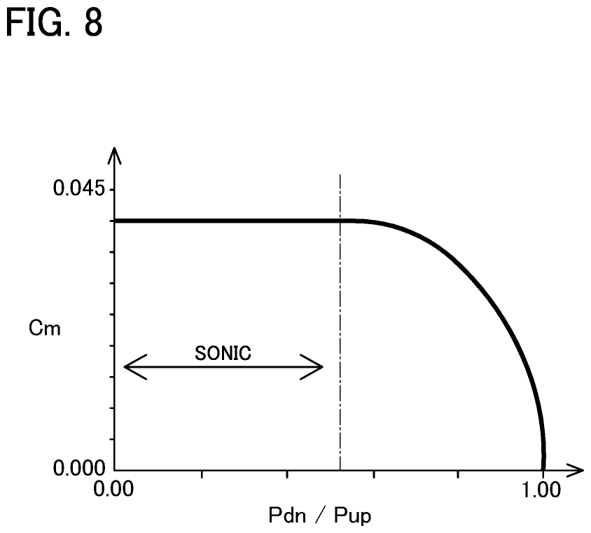

In step 410, the ECU 50 can calculate an actual opening degree (an intake actual opening degree) ADR of the inlet valve 28 based on the detected intake amount Ga and the foregoing basic expression (F). In this step 410, in the basic expression (F), “dm” indicates the intake amount Ga and is known, “A” denotes the opening area of the inlet valve 28 and has production variation, “Cq” denotes a flow rate coefficient of the inlet valve 28 and is known, and “Cm” denotes a flow coefficient of the inlet valve 28 and can be obtained from a relationship between the pressure Pdn on a downstream side of the inlet valve 28 (Intake negative pressure) and the pressure Pup on an upstream side of the inlet valve 28. FIG. 8 is a graph showing a relationship between a ratio (Pdn/Pup) of the downstream pressure Pdn to the upstream pressure Pup of a certain valve and the flow coefficient Cm. The flow coefficient Cm of the inlet valve 28 can be specified from this graph. In the basic expression (F), “Pup” indicates the pressure on an upstream side of the inlet valve 28, corresponding to atmospheric pressure, and is known, and “Pdn” corresponds to the pressure Pup on an upstream side of the throttle valve 6a. This Pup can be obtained by applying the basic expression (F) to a part of the throttle valve 6a. The opening area A of the throttle valve 6 is known in step 360. Further, “dm”, “Tup”, and “Cq” are each known. In the electronic throttle device 6, the velocity of the intake air is sonic and thus “Cm” is known. Using those values, “Pup” can be calculated. Consequently, the opening area A when the inlet valve 28 is set to a predetermined master opening degree can be specified by the basic expression (F) and accordingly the intake actual opening degree ADR can be obtained.

In step 420, successively, the ECU 50 learns an intake opening degree correction value ADC. That is, the ECU 50 obtains a difference between the intake actual opening degree ADR and the master opening degree of the inlet valve 28 as the intake opening degree correction value ADC and stores it in a memory.

In step 430, the ECU 50 corrects an intake opening degree map value (intake opening degree correction). Specifically, the ECU 50 corrects the intake opening degree map value with the intake opening degree correction value ADC. For example, the ECU 50 can obtain a corrected target value (the intake opening degree map value) by adding or subtracting the intake opening degree correction value ADC to or from an uncorrected target value (the intake opening degree map value). This correction of the intake opening degree map value can eliminate opening-degree variation due to production tolerance and variation with time of the inlet valve 28.

After completion of the intake opening degree correction in step 430, the processing is shifted from step 380 to step 440, in which the ECU 50 determines whether or not purge opening degree correction for the purge valve 36 has been completed. When this determination result is negative, the ECU 50 shifts the processing to step 450. When this determination result is affirmative, the ECU 50 returns the processing to step 300.

In step 450, the ECU 50 executes the processing of a purge opening degree measurement mode 1 for the purge valve 36. Specifically, in a similar manner to FIG. 7, the ECU 50 sets the corrected opening degree of the electronic throttle device 6 to a predetermined value (e.g., equivalent to 7 deg), sets the corrected opening degree of the inlet valve 28 to a predetermined value (e.g., equivalent to 6 deg), and sets the master opening degree of the purge valve 36 to full close (0%) defined as a first opening degree. At that time, the intake air passes through the electronic throttle device 6 at sonic velocity and the intake air passes through the inlet valve 28 at subsonic velocity.

In step 460, the ECU 50 then takes the intake amount Ga based on a detection value of the air flow meter 42. Also in this case, the velocity of the intake air passing through the electronic throttle device 6 is sonic, so that the intake amount Ga detected by the air flow meter 42 is a steady constant value.

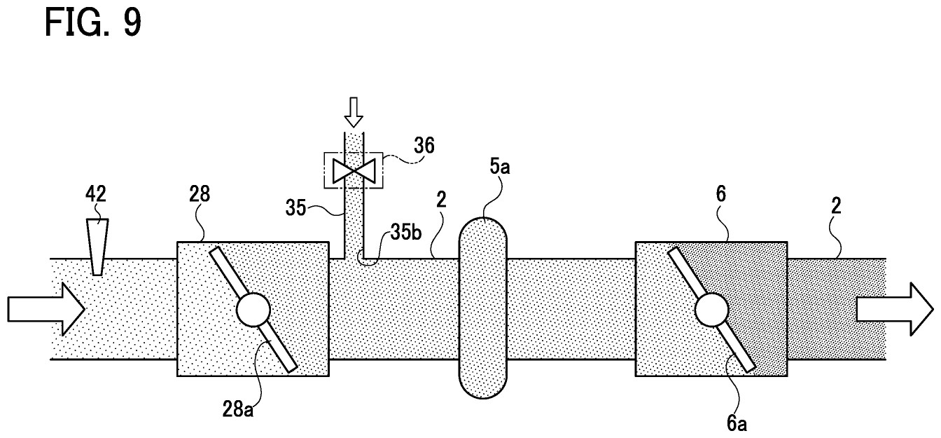

In step 470, the ECU 50 executes the processing of a purge opening degree measurement mode 2 for the purge valve 36. FIG. 9 is a conceptual diagram showing each state of the electronic throttle device 6, the inlet valve 28, and the purge valve 36 at that time. Specifically, as shown in FIG. 9, the ECU 50 sets the corrected opening degree of the electronic throttle device 6 to a predetermined value (e.g., equivalent to 7 deg), sets the corrected opening degree of the inlet valve 28 to a predetermined value (e.g., equivalent to 6 deg), and sets the master opening degree of the purge valve 36 to a predetermined value (e.g., 10%) as a second opening degree to open the purge valve 36 from a fully closed position. At that time, the intake air passes through the electronic throttle device 6 at sonic velocity, the intake air passes through the inlet valve 28 at subsonic velocity, and the gas containing vapor passes through the purge valve 36 at subsonic velocity.

In step 480, the ECU 50 takes the intake amount Ga based on a detection value of the air flow meter 42. Also in this case, the velocity of the intake air passing through the electronic throttle device 6 is sonic, so that the intake amount Ga detected by the air flow meter 42 is a steady constant value.

In step 490, the ECU 50 calculates an actual opening degree (a purge actual opening degree) PAR of the purge valve 36 by use of a pressure difference (front-rear differential pressure) between the upstream pressure and the downstream pressure of the purge valve 36 and the purge flow rate of vapor passing through the purge valve 36. Herein, the pressure on a downstream side of the inlet valve 28 (corresponding to a downstream side of the purge valve 36) when the inlet valve 28 is opened at the predetermined corrected opening degree (e.g., equivalent to 6 deg) is known (can be accurately estimated), and the upstream pressure of the purge valve 36 is substantially an atmospheric pressure while the velocity of intake air is sonic, so that the front-rear differential pressure of the purge valve 36 is known. Further, the purge flow rate of vapor passing through the purge valve 36 can be obtained based on a change rate of the intake amount Ga in step 480 with respect to the intake amount Ga in step 460. From a relationship between those front-rear differential pressure, purge flow rate, flow rate coefficient, and flow coefficient of the purge valve 36, the opening area when the purge valve 36 is set to the predetermined master opening degree (e.g., 10%) can be specified. Accordingly, the purge actual opening degree PAR can be obtained.

In step 500, the ECU 50 learns a purge opening degree correction value PAC. Specifically, the ECU 50 obtains a difference between the purge actual opening degree PAR and the master opening degree of the purge valve 36 as the purge opening degree correction value PAC and stores it in a memory.

In step 510, the ECU 50 corrects a purge opening degree map value (purge opening degree correction). Specifically, the ECU 50 corrects the purge opening degree map value with the purge opening degree correction value PAC. For instance, the ECU 50 can obtain a corrected target value (the purge opening degree map value) by adding or subtracting the purge opening degree correction value PAC to or from an uncorrected target value (the purge opening degree map value). This correction of the purge opening degree map value can eliminate opening-degree variation due to production tolerance and variation with time of the purge valve 36.

After completion of the purge opening degree correction in step 510, the ECU 50 returns the processing from step 440 to step 300.

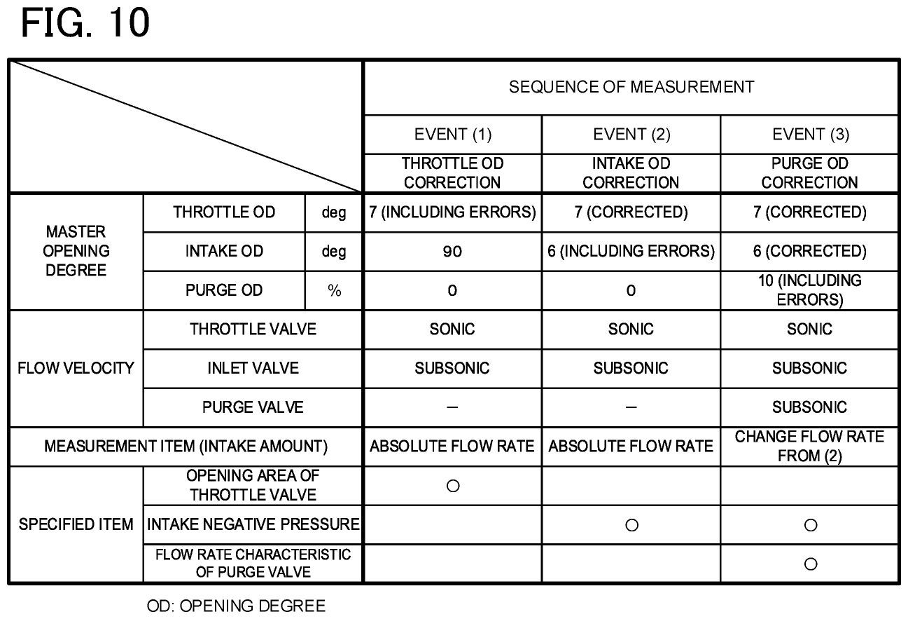

Herein, FIG. 10 is a table organized to show all of master opening degree, flow velocity, measurement item (intake amount), and specified item, which are related to the throttle opening degree correction (event (1)), the intake opening degree correction (event (2)), and the purge opening degree correction (event (3)). In the throttle opening degree correction in event (1), as shown in FIG. 10, the throttle opening degree is set to 7 deg (including errors) which is the master opening degree, the intake opening degree is set to 90 deg which is the master opening degree, and the purge opening degree is set to 0% which is the master opening degree. The flow velocity at that time is sonic in the throttle valve 6a (the electronic throttle device 6) and subsonic in the inlet valve 28. The measurement item (intake amount) is the absolute flow rate. The specified item is the opening area of the throttle valve 6a.

In the intake opening degree correction in event (2), the throttle opening degree is set to equivalent to 7 deg which is the corrected opening degree, the intake opening degree is set to 6 deg (including errors) which is the master opening degree, and the purge opening degree is set to 0% which is the master opening degree. The flow velocity at that time is sonic in the throttle valve 6a and subsonic in the inlet valve 28. Further, the measurement item (intake amount) is the absolute flow rate. The specified item is the intake negative pressure.

In the purge opening degree correction in event (3), the throttle opening degree is set to equivalent to 7 deg which is the corrected opening degree, the intake opening degree is set to equivalent to 6 deg which is the corrected opening degree, and the purge opening degree is set to 10% (including errors) which is the master opening degree. The flow velocity at that time is sonic in the throttle valve 6a, subsonic in the inlet valve 28, and subsonic in the purge valve 36. Furthermore, the measurement item (intake amount) is the change flow rate from event (2). The specified item is the intake negative pressure and the flow rate characteristic of the purge valve.

According to the control device of a supercharger-equipped engine in the present embodiment described above, the ECU 50 (the control unit) executes the foregoing second opening-degree variation correction control during operation of the engine 1. In this correction control, the ECU 50 controls the purge valve 36 (the gas flow regulating valve) to fully close and the inlet valve 28 to fully open, and further controls the electronic throttle device 6 (the intake amount regulating valve) to the master opening degree which is an arbitrary controlled opening degree so that the intake air passes through the electronic throttle device 6 at sonic velocity. At that time, the ECU 50 obtains the throttle actual opening degree TAR (the actual opening degree) of the electronic throttle device 6 based on the intake amount Ga detected by the air flow meter 42 (the intake amount detecting unit) and the predetermined basic expression (F) representing the valve passing flow rate, learns the throttle opening degree correction value TAC (the opening degree correction value) of the electronic throttle device 6 from a difference between the obtained throttle actual opening degree TAR and the arbitrary master opening degree, and corrects the control of the electronic throttle device 6 based on the leant throttle opening degree correction value TAC.

After correcting the control of the electronic throttle device 6 based on the learnt throttle opening degree correction value TAC, the ECU 50 successively controls the purge valve 36 to fully close and controls the inlet valve 28 to close to the master opening degree corresponding to the arbitrary controlled opening degree. At that time, the ECU 50 obtains the intake actual opening degree ADR (the actual opening degree) of the inlet valve 28 based on the intake amount Ga detected by the air flow meter 42 and the basic expression (F) representing the valve passing flow rate, learns the intake opening degree correction value ADC (the opening degree correction value) of the inlet valve 28 from a difference between the obtained intake actual opening degree ADR and the arbitrary master opening degree of the inlet valve 28, and corrects the control of the inlet valve 28 based on the learnt intake opening degree correction value ADC. According to the second opening-degree variation correction control, therefore, the control of the electronic throttle device 6 and the control of the inlet valve 28 are corrected without particular use of a dedicated pressure sensor for detecting the downstream pressure Pdn of the inlet valve 28. Thus, when the purge valve 36 is opened, the purge flow rate of purge gas allowed to flow in the intake passage 2 is corrected regardless of the presence/absence of the opening-degree variation of the inlet valve 28. Consequently, the purge flow rate can be accurately controlled without particular use of a dedicated pressure sensor regardless of the opening-degree variation of the inlet valve 28. This configuration corresponds to the technique recited in claims 4 to 6 of the present application.

Furthermore, the ECU 50 successively corrects the control of the electronic throttle device 6 based on the learnt throttle opening degree correction value TAC and corrects the control of the inlet valve 28 based on the learnt intake opening degree correction value ADC, and then obtains, as a change flow rate of purge gas (a purge flow-rate change rate), a change rate of the intake amount Ga detected by the air flow meter 42 when the purge valve 36 is controlled to a predetermined second opening degree (e.g., 10%) lager than a predetermined first opening degree (e.g., full close: 0%) with respect to the intake amount Ga detected by the air flow meter 42 when the purge valve 36 is controlled to the first opening degree. The ECU 50 further obtains a pressure difference between the upstream pressure and the downstream pressure of the purge valve 36 when the purge valve 36 is controlled to open to the second opening degree based on the foregoing basic expression (F) representing the valve passing flow rate. The ECU 50 obtains the purge actual opening degree PAR (the actual opening degree) of the purge valve 36 based on the obtained purge flow-rate change rate and the pressure difference, learns the purge opening degree correction value PAC (the opening degree correction value) of the purge valve 36 from a difference between the obtained purge actual opening degree PAR and the second opening degree, and corrects the control of the purge valve 36 based on the learnt purge opening degree correction value PAC. According to this second opening-degree variation correction control, therefore, the control of the purge valve 36 is corrected without particular use of a dedicated pressure sensor for detecting the downstream pressure of the inlet valve 28. Thus, when the purge valve 36 is opened, the purge flow rate allowed to flow from the purge passage 35 into the intake passage 2 is corrected regardless of the presence/absence of the opening-degree variation of the purge valve 36. Consequently, the purge flow rate can be accurately controlled without particular use of a dedicated pressure sensor regardless of the opening-degree variation of the purge valve 36.

Specifically, according to the configuration in the present embodiment, a difference between each of the actual opening degrees (the throttle actual opening degree TAR, the intake actual opening degree ADR, and the purge actual opening degree PAR) of the electronic throttle device 6 (the throttle valve 6a), the inlet valve 28, and the purge valve 36 and each corresponding predetermined various master opening degree is calculated based on the intake amount Ga detected by the air flow meter 42 and the basic expression (F) representing the valve passing flow rate, and the controls of various valves 6a, 28, and 36 are corrected to a center of tolerance. Thus, variations in purge flow rate can be reduced.

### Third Embodiment

Next, a third embodiment that embodies the control device of a supercharger-equipped engine in a gasoline engine system will be described in detail with reference to accompanying drawings.

The present embodiment differs from the first embodiment in that an exhaust recirculation device (an EGR device) is added to the engine system and accordingly the contents of the opening-degree variation correction control are changed.

(Engine System)

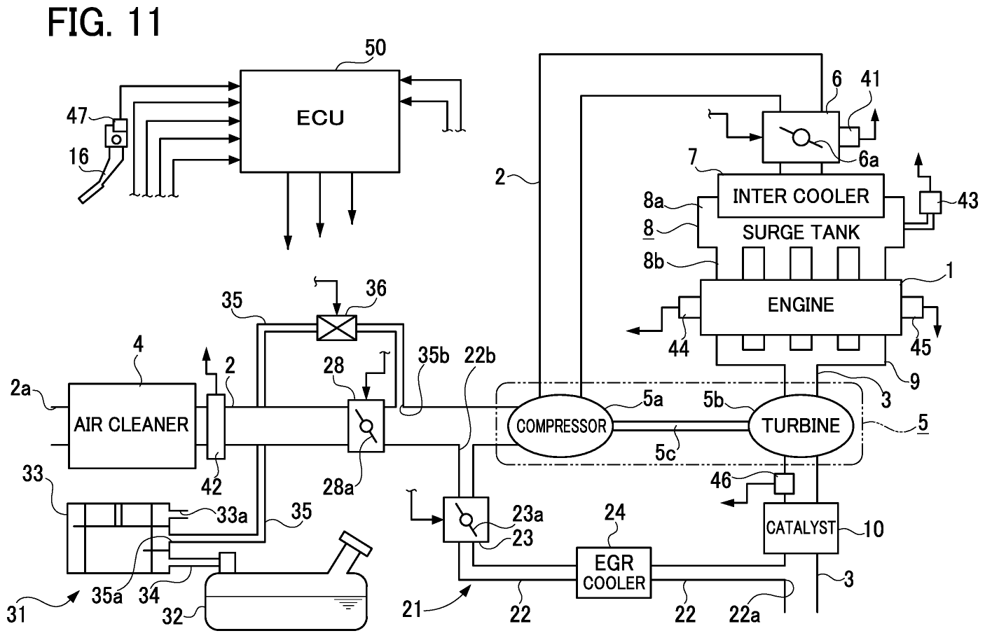

FIG. 11 is a schematic diagram showing the engine system in the present embodiment. As shown in FIG. 11, this engine system differs in the following configuration from the engine system in the first embodiment. Specifically, this engine system is further provided with a low-pressure loop EGR device 21. This EGR device 21 is configured to allow a part of exhaust gas discharged from each cylinder to the exhaust passage 3 to flow as an exhaust recirculation gas (EGR gas) into the intake passage 2 to return to each cylinder of the engine 1. This EGR device 21 includes an exhaust recirculation passage (an EGR passage) 22 for flowing the EGR gas from the exhaust passage 3 to the intake passage 2 and an exhaust recirculation valve (an EGR valve) 23 configured to have an adjustable opening degree to regulate an EGR gas flow rate in the EGR passage 22. The EGR passage 22 includes an inlet 22a and an outlet 22b. The inlet 22a of the EGR passage 22 is connected to the exhaust passage 3 downstream from the catalyst 10 and the outlet 22b of the same passage 22 is connected to the intake passage 2 upstream from the compressor 5a and downstream from the inlet valve 28. In the EGR passage 22 upstream from the EGR valve 23, an EGR cooler 24 is provided to cool the EGR gas.

In the embodiment, the EGR valve 23 is constituted of an electrically-operated valve using a DC motor and includes a valve element 23a that is driven to change its opening degree. This EGR valve 23 preferably has a high flow rate, high response, and high resolution characteristic. In the present embodiment, therefore, the EGR valve 23 may be configured as a double eccentric valve disclosed in for example Japanese Patent No. 5759646. This double eccentric valve is configured for high flow rate control.

In this engine system, the EGR valve 23 is configured to open in a supercharging region in which the supercharger 5 is operated (a region in which the intake amount is relatively high). Accordingly, a part of the exhaust gas flowing through the exhaust passage 3 flows as EGR gas to the EGR passage 22 through the inlet 22a, flows to the intake passage 2 through the EGR cooler 24 and the EGR valve 23, and then returns to each cylinder of the engine 1 through the compressor 5a, the electronic throttle device 6, the intercooler 7, and the intake manifold 8.

In the present embodiment, the ECU 50 is connected to the EGR valve 23. The ECU 50 is configured to execute EGR control as well as the foregoing fuel injection control, ignition timing control, and intake control based on various signals outputted from the various sensors and others 41 to 47. The EGR control is to control the EGR valve 23 and the inlet valve 28 according to an operating state of the engine 1 to control an EGR gas flow rate of EGR gas allowed to return to the engine 1. During deceleration of the engine 1, the ECU 50 is configured to control the EGR valve 23 to fully close in order to shut off a flow of the EGR gas to the engine 1 (EGR cut).

(Third Opening-Degree Variation Correction Control)

Herein, the electronic throttle device 6, the inlet valve 28, the purge valve 36, and the EGR valve 23 mentioned above have some opening-degree variations (including production variation within tolerance and variation with time). Further, depending on the opening-degree variation of the inlet valve 28, the negative pressure acting on the outlet 35b of the purge passage 35 and the negative pressure acting on the outlet 22b of the EGR passage 22 may deviate from respective target values. Moreover, depending on the opening-degree variation of the purge valve 36, the purge flow rate of purge gas flowing from the purge passage 35 to the intake passage 2 may deviate from a target value, leading to deterioration in control accuracy of the purge flow rate during execution of the purge control. Furthermore, depending on the opening-degree variation of the EGR valve 23, the EGR gas flow rate of EGR gas flowing from the EGR passage 22 to the intake passage 2 may deviate from a target value, leading to deterioration in control accuracy of the EGR gas flow rate during execution of the EGR control. In the present embodiment, therefore, for the purpose of enhancing the control accuracy of the purge flow rate and the EGR gas flow rate while enhancing the accuracy of controlling the intake pressure (the negative pressure) by the inlet valve 28, regardless of the opening-degree variation of the inlet valve 28, the ECU 50 is configured to execute the third control to correct opening-degree variations (“third opening-degree variation correction control”) as described below.

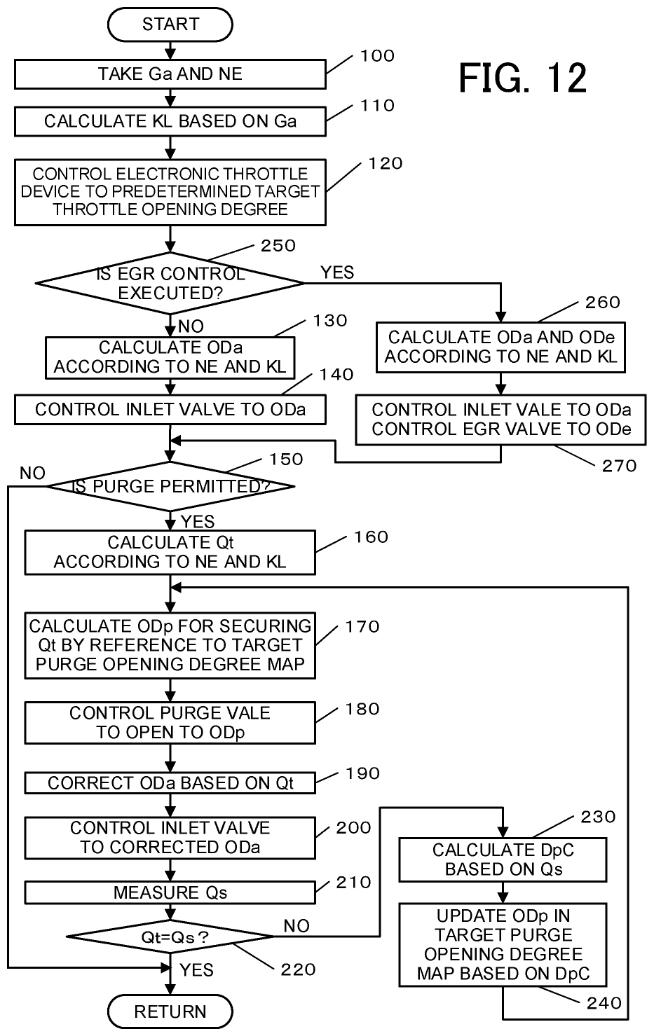

FIG. 12 is a flowchart showing contents of the third opening-degree variation correction control. The flowchart in FIG. 12 differs from the flowchart in FIG. 2 in that step 250 to step 270 are added between step 120 and step 130.

When the processing is shifted to this routine, the ECU 50 executes the processings in step 100 to step 120 and then, in step 250, determines whether or not the EGR control is being executed. When this determination result is negative, representing that the EGR control is not being executed, the ECU 50 shifts the processing to step 130 and executes the processings in step 130 to step 240. When this determination result is affirmative, representing that the EGR control is being executed, in contrast, the ECU 50 shifts the processing to step 260.

In step 260, the ECU 50 calculates a target intake opening degree ODa for the inlet valve 28 and a target EGR opening degree ODe for the EGR valve 23, according to the taken engine rotation speed NE and engine load KL, by reference to a predetermined function map.

In step 270, the ECU 50 then controls the inlet valve 28 to the calculated target intake opening degree ODa and also controls the EGR valve 223 to the calculated target EGR opening degree ODe.

Subsequently, the ECU 50 shifts the processing to step 150 and executes the processings in step 150 to step 240.

According to the above-described third opening-degree variation correction control, differently from the first opening-degree variation correction control in the first embodiment, when the ECU 50 controls the electronic throttle device 6 (the intake amount regulating valve) to the target throttle opening degree (a predetermined opening degree) and controls the inlet valve 28 to the target intake opening degree ODa according to the engine rotation speed NE and the engine load KL (the operating state of the engine 1), the ECU 50 further controls the EGR valve 23 to the target EGR opening degree ODe according to the engine rotation speed NE and the engine load KL (the operating state of the engine 1). While controlling the electronic throttle device 6, the inlet valve 28, and the EGR valve 23, the ECU 50 calculates the target purge flow rate Qt (the target gas flow rate) of purge gas to be purged (supplied) to the intake passage 2 according to the engine rotation speed NE and the engine load KL (the operating state of the engine 1), and calculates the target purge opening degree ODp (the target gas flow rate opening degree) for securing the target purge flow rate Qt based on a predetermined target purge opening degree map (function data). The ECU 50 controls the purge valve 36 (the gas flow regulating valve) to the target purge opening degree ODp and also corrects the target intake opening degree ODa based on the target purge flow rate Qt, and controls the inlet valve 28 with the corrected target intake opening degree ODa. This configuration corresponds to the technique recited in claim 3 of the present application.

The control device of a supercharger-equipped engine in the present embodiment described above can provide the equivalent operations and effects to those in the first embodiment, and further provide different operations and effects as below. According to this third opening-degree variation correction control, specifically, in a specific state where the electronic throttle device 6 is controlled to the predetermined target throttle opening degree, the inlet valve 28 is controlled to the target intake opening degree Oda, and also the EGR valve 23 is controlled to the target EGR opening degree ODe, the target purge flow rate Qt of purge gas to be supplied from the purge passage 35 to the intake passage 2 is calculated. Further, the target purge opening degree ODp for securing the target purge flow rate Qt is calculated based on the predetermined target purge opening degree map. Then, the purge valve 36 is controlled to the calculated target purge opening degree ODp and also the target intake opening degree ODa is corrected based on the target purge flow rate Qt, and the inlet valve 28 is controlled with the corrected intake opening degree ODa. Since the inlet valve 28 is controlled to the target intake opening degree ODa corrected based on the target purge flow rate Qt, therefore, the actual intake pressure immediately downstream from the inlet valve 28 is corrected according to the purge flow rate to be supplied. Consequently, while enhancing the control accuracy of the intake negative pressure by the inlet valve 28 without using a dedicated pressure sensor, regardless of the opening-degree variation of the inlet valve 28, the ECU 50 can accurately control a predetermined purge flow rate and a predetermined EGR gas flow rate allowed to flow in the intake passage 2.

### Fourth Embodiment

Next, a fourth embodiment that embodies the control device of a supercharger-equipped engine in a gasoline engine system will be described in detail with reference to accompanying drawings.

In the following description, similar or identical components to those in the third embodiment are assigned the same reference signs and their details are omitted. The following description will be made with a focus on differences from the third embodiment. The fourth embodiment differs from the third embodiment in contents of the opening-degree variation correction control.

(Fourth Opening-Degree Variation Correction Control)

In the engine system shown in FIG. 11, the electronic throttle device 6, the inlet valve 28, the purge valve 36, and the EGR valve 23 mentioned above have some opening-degree variations (including production variation within tolerance and variation with time). Further, depending on the opening-degree variation of the inlet valve 28, the intake pressure (the negative pressure) acting on the outlet 35b of the purge passage 35 and on the outlet 22b of the EGR passage 22 may deviate from respective target values. Moreover, depending on the opening-degree variation of the purge valve 36, the purge flow rate of purge gas flowing from the purge passage 35 to the intake passage 2 may deviate from a target value, leading to deterioration in control accuracy of the purge flow rate during execution of the purge control.

Furthermore, depending on the opening-degree variation of the EGR valve 23, the EGR gas flow rate of EGR gas flowing from the EGR passage 22 to the intake passage 2 may deviate from a target value, leading to deterioration in control accuracy of the EGR gas flow rate during execution of the EGR control. In the present embodiment, therefore, for the purpose of enhancing the accuracy of controlling the purge flow rate and the EGR gas flow rate, regardless of the opening-degree variation of the inlet valve 28, the opening-degree variation of the purge valve 36, and further the opening-degree variation of the EGR valve 23, the ECU 50 is configured to execute the fourth control to correct opening-degree variations (“fourth opening-degree variation correction control”) as described below.

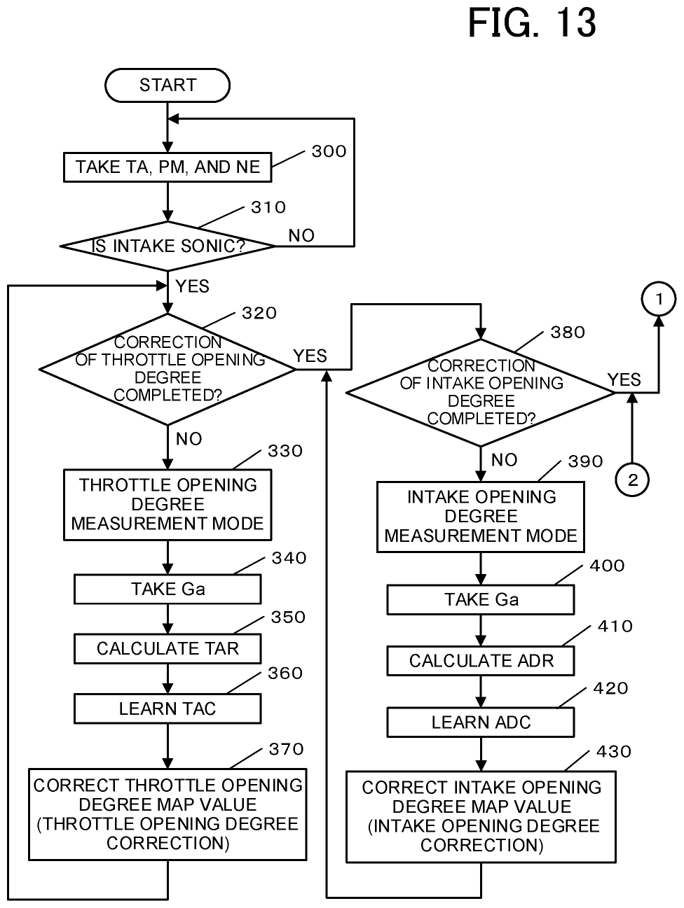

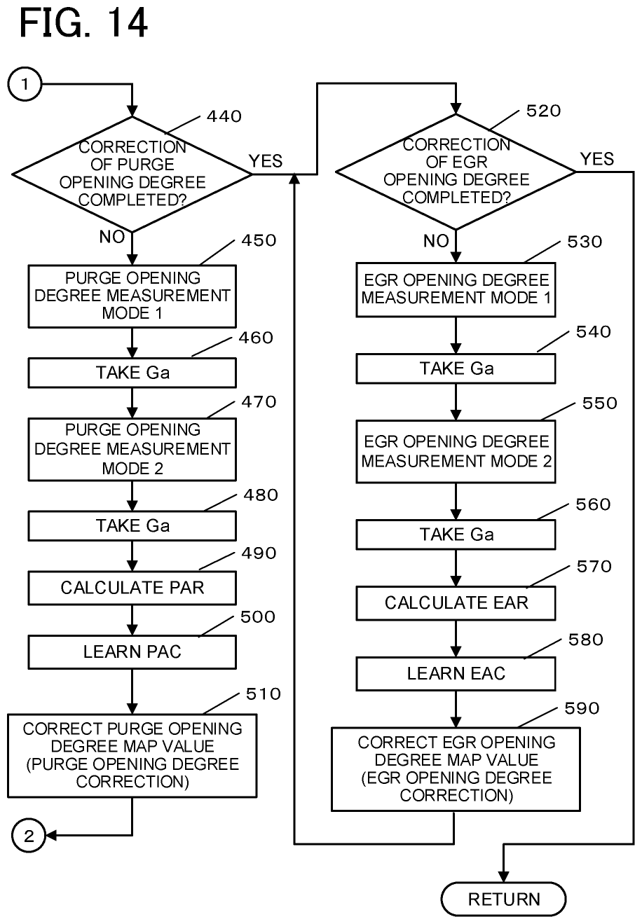

FIGS. 13 and 14 are flowcharts each showing contents of the fourth opening-degree variation correction control. The flowcharts in FIGS. 13 and 14 differ from the flowchart in FIG. 4 in that step 520 to step 590 are added to follow an affirmative determination (YES) in step 440. The following description will be made referring to the flowcharts in FIGS. 13 and 14 with a focus on different contents from the flowchart in FIG. 4.

When the processing is shifted to this routine, the ECU 50 executes the processings in step 300 to step 510 in a similar manner as in the second embodiment.

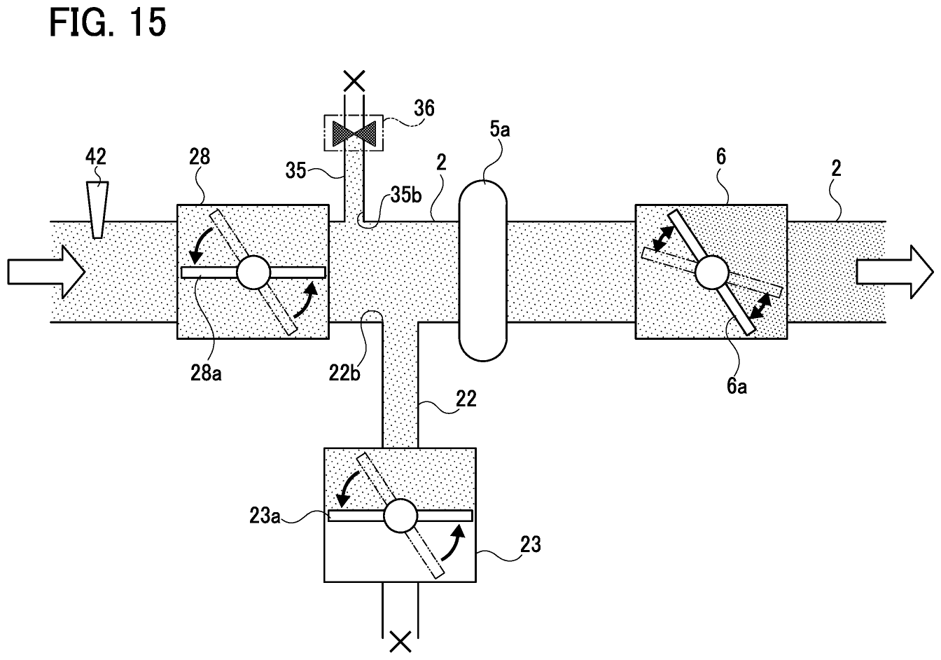

Herein, in step 330, the ECU 50 executes the processing of the throttle opening degree measurement mode for the electronic throttle device 6. FIG. 15 is a conceptual diagram showing each state of the electronic throttle device 6, the inlet valve 28, the purge valve 36, and the EGR valve 23. Specifically, as shown in FIG. 15, the ECU 50 sets the master opening degree of the electronic throttle device 6 to a predetermined value (e.g., 7 deg), sets the master opening degree of the inlet valve 28 to full open (90 deg), sets the master opening degree of the purge valve 36 to full close (0%), and sets the master opening degree of the EGR valve 23 to full close (0%). At that time, the intake air passes through the electronic throttle device 6 at sonic velocity, the intake air passes through the inlet valve 28 at subsonic velocity, and the pressure on an upstream side of the electronic throttle device 6 is substantially an atmospheric pressure (known).

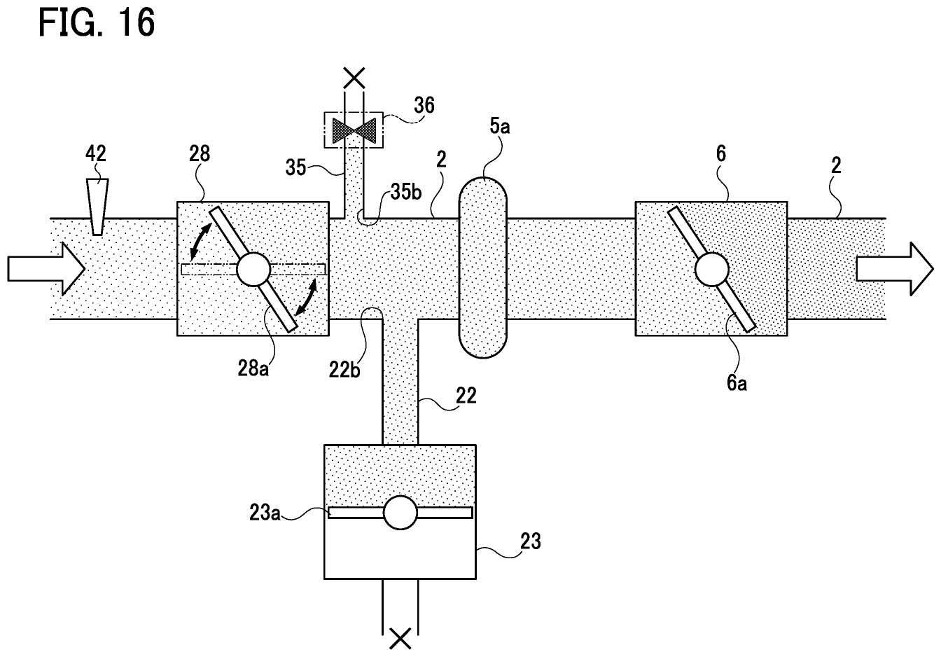

After executing the processings in step 340 to step 380, subsequently, the ECU 50 executes, in step 390, the processing of the intake opening degree measurement mode for the inlet valve 28. FIG. 16 is a conceptual diagram showing each state of the electronic throttle device 6, the inlet valve 28, the purge valve 36, and the EGR valve 23 at that time. Specifically, as shown in FIG. 16, the ECU 50 sets the corrected opening degree of the electronic throttle device 6 to a predetermined value (e.g., equivalent to 7 deg), sets the master opening degree of the inlet valve 28 to a predetermined value (e.g., 6 deg) to close the inlet valve 28 from a fully open position, sets the master opening degree of the purge valve 36 to full close (0%), and sets the master opening degree of the EGR valve 23 to full close (0%). At that time, the flow velocity of intake air passing through the electronic throttle device 6 is sonic, the flow velocity of intake air passing through the inlet valve 28 is subsonic, and the upstream pressure of the inlet valve 28 is an atmospheric pressure (known).

After executing the processings in step 400 to step 440, subsequently, the ECU 50 executes, in step 450, the throttle opening degree measurement mode 1 for the purge valve 36. Specifically, in a similar manner to FIG. 16, the ECU 50 sets the corrected opening degree of the electronic throttle device 6 to a predetermined value (e.g., equivalent to 7 deg), sets the corrected opening degree of the inlet valve 28 to a predetermined value (e.g., equivalent to 6 deg), sets the master opening degree of the purge valve 36 to full close (0%) defined as the first opening degree, and sets the master opening degree of the EGR valve 23 to full close (0%). At that time, the flow velocity of intake air passing through the electronic throttle device 6 is sonic and the flow velocity of intake air passing through the inlet valve 28 is subsonic.

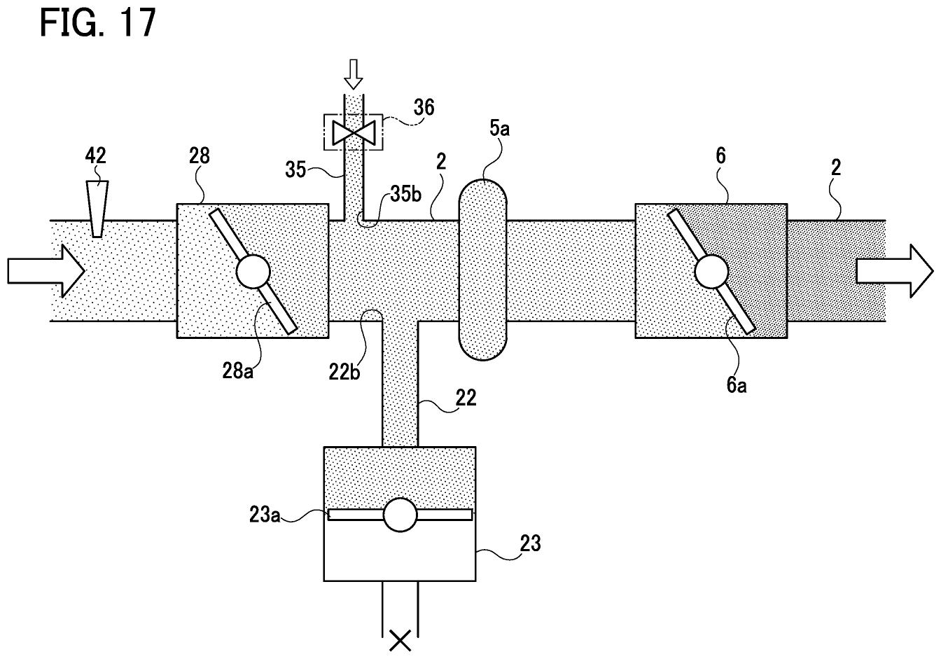

After executing the processing in step 460, subsequently, the ECU 50 executes, in step 470, the processing of the purge opening degree measurement mode 2 for the purge valve 36. FIG. 17 is a conceptual diagram showing each state of the electronic throttle device 6, the inlet valve 28, the purge valve 36, and the EGR valve 23 at that time. Specifically, as shown in FIG. 17, the ECU 50 sets the corrected opening degree of the electronic throttle device 6 to a predetermined value (e.g., equivalent to 7 deg), sets the corrected opening degree of the inlet valve 28 to a predetermined value (e.g., equivalent to 6 deg), sets the master opening degree of the purge valve 36 to a predetermined value (e.g., 10%) defined as the second opening degree to open the purge valve 36 from a fully closed position, and sets the master opening degree of the EGR valve 23 to full close (0%). At that time, the flow velocity of intake air passing through the electronic throttle device 6 is sonic, the flow velocity of intake air passing through the inlet valve 28 is subsonic, and the flow velocity of gas containing vapor passing through the purge valve 36 is subsonic.

Subsequently, after executing the processings in step 480 to step 510 and completing the purge opening degree correction in step 440, the ECU 50 determines, in step 520, whether or not the EGR opening degree correction for the EGR valve 23 has been completed. When this determination result is affirmative, the ECU 50 returns the processing to step 300. When this determination result is negative, the ECU 50 shifts the processing to step 530.

In step 530, the ECU 50 executes the processing of an EGR opening degree measurement mode 1 for the EGR valve 23. Specifically, in a similar manner to FIG. 16, the ECU 50 sets the corrected opening degree of the electronic throttle device 6 to a predetermined value (e.g., equivalent to 7 deg), sets the corrected opening degree of the inlet valve 28 to a predetermined value (e.g., equivalent to 6 deg), sets the master opening degree of the purge valve 36 to full close (0%) defined as the first opening degree, and sets the master opening degree of the EGR valve 23 to full close (0%) defined as the first opening degree. At that time, the flow velocity of intake air passing through the electronic throttle device 6 is sonic and the flow velocity of intake air passing through the inlet valve 28 is subsonic.

In step 540, the ECU 50 then takes the intake amount Ga based on a detection value of the air flow meter 42. In this state, the intake air also passes through the electronic throttle device 6 at sonic velocity, so that the intake amount Ga detected by the air flow meter 42 is a steady constant value.

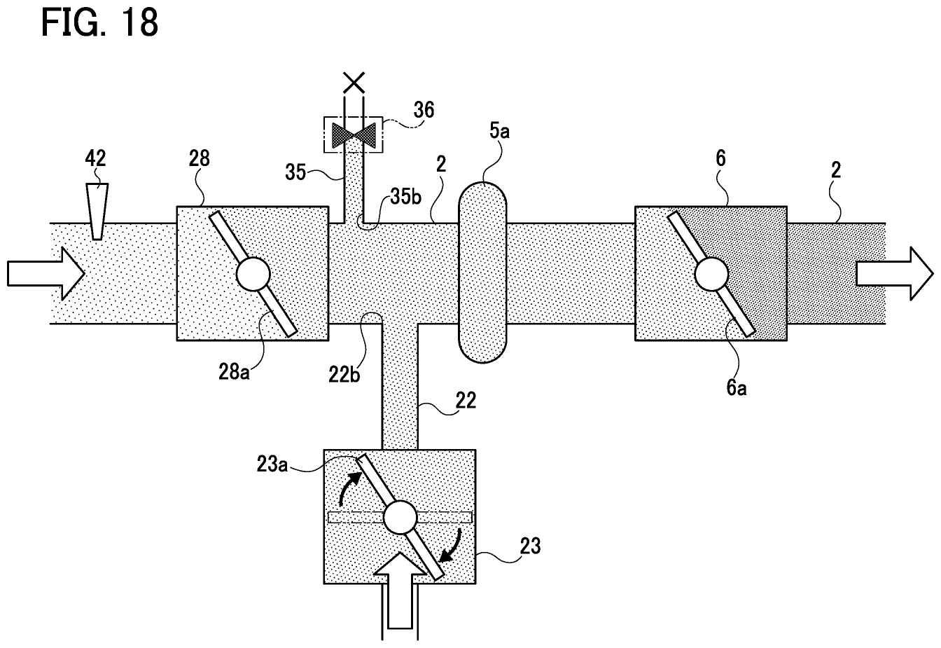

In step 550, the ECU 50 executes the processing of an EGR opening degree measurement mode 2 for the EGR valve 23. FIG. 18 is a conceptual diagram showing each state of the electronic throttle device 6, the inlet valve 28, the purge valve 36, and the EGR valve 23 at that time. Specifically, as shown in FIG. 18, the ECU 50 sets the corrected opening degree of the electronic throttle device 6 to a predetermined value (e.g., equivalent to 7 deg), sets the corrected opening degree of the inlet valve 28 to a predetermined value (e.g., equivalent to 6 deg), sets the master opening degree of the purge valve 36 to full close (0%), and sets the master opening degree of the EGR valve 23 to a predetermined value (e.g., 25%) defined as the second opening degree to open the EGR valve 23 from full close. At that time, the flow velocity of intake air passing through the electronic throttle device 6 is sonic, the flow velocity of intake air passing through the inlet valve 28 is subsonic, and the flow velocity of EGR gas passing through the EGR valve 23 is subsonic.

In step 560, the ECU 50 then takes the intake amount Ga based on a detection value of the air flow meter 42. Also, at that time, the intake air passes through the electronic throttle device 6 at sonic velocity, so that the intake amount Ga detected by the air flow meter 42 is a steady constant value.

In step 570, the ECU 50 calculates an actual opening degree EAR of the EGR valve 23 (an EGR actual opening degree) by use of a pressure difference between the upstream pressure and the downstream pressure of the EGR valve 23 (the front-rear differential pressure) and the EGR gas flow rate of EGR gas passing through the EGR valve 23. Herein, the pressure on a downstream side of the inlet valve 28 (corresponding to also a downstream side of the EGR valve 23) when the inlet valve 28 is opened at the predetermined corrected opening degree (e.g., equivalent to 6 deg) is known (can be accurately estimated), and the upstream pressure of the EGR valve 23 is substantially an atmospheric pressure while the velocity of intake air is sonic, so that the front-rear differential pressure of the EGR valve 23 is known. Further, the EGR gas flow rate passing through the EGR valve 23 can be obtained from a change rate of the intake amount Ga in step 560 with respect to the intake amount Ga in step 540. From a relationship between those front-rear differential pressure, EGR gas flow rate, flow rate coefficient, and flow coefficient of the EGR valve 23, the opening area when the EGR valve 23 is set to the predetermined master opening degree (e.g., 25%) can be specified. Accordingly, the EGR actual opening degree EAR can be obtained.

In step 580, the ECU 50 learns an EGR opening degree correction value EAC. Specifically, the ECU 50 obtains, as the EGR opening degree correction value EAC, a difference between the EGR actual opening degree EAR and the master opening degree of the EGR valve 23 and stores it in a memory.

In step 590, the ECU 50 corrects the EGR opening degree map value (EGR opening degree correction). Specifically, the ECU 50 corrects the EGR opening degree map value with the EGR opening degree correction value EAC. For example, the ECU 50 can obtain a corrected target value (the EGR opening degree map value) by adding or subtracting the EGR opening degree correction value EAC to or from an uncorrected target value (the EGR opening degree map value). This correction of the EGR opening degree map value can eliminate opening-degree variation due to production tolerance and variation with time of the EGR valve 23.

After completion of correction of the EGR opening degree in step 590, the ECU 50 returns the processing from step 520 to step 300.

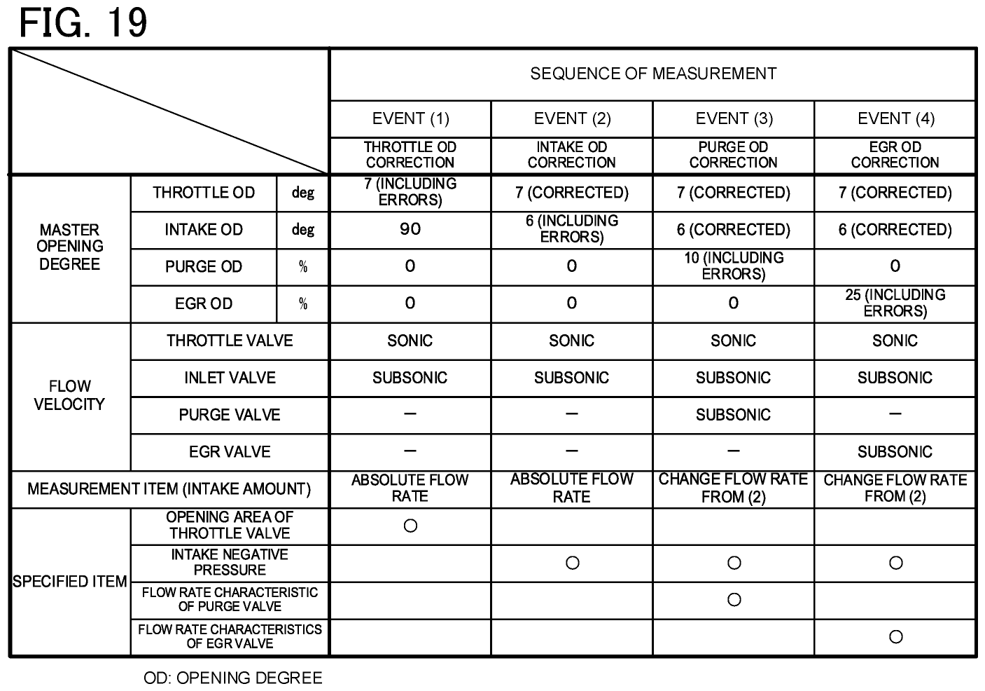

Herein, FIG. 19 is a table organized to show all of master opening degree, flow velocity, measurement item (intake amount), and specified item, which are related to the throttle opening degree correction (event (1)), the intake opening degree correction (event (2)), the purge opening degree correction (event (3)), and the EGR opening degree correction (event (4)). In the throttle opening degree correction in event (1), as shown in FIG. 19, the throttle opening degree is set to 7 deg (including errors) which is the master opening degree, the intake opening degree is set to 90 deg which is the master opening degree, the purge opening degree is set to 0% which is the master opening degree, and the EGR opening degree is set to 0% which is the master opening degree. The flow velocity at that time is sonic in the throttle valve 6a (the electronic throttle device 6) and subsonic in the inlet valve 28. The measurement item (intake amount) is the absolute flow rate. The specified item is the opening area of the throttle valve 6a.

In the intake opening degree correction in event (2), the throttle opening degree is set to equivalent to 7 deg which is the corrected opening degree, the intake opening degree is set to 6 deg (including errors) which is the master opening degree, the purge opening degree is set to 0% which is the master opening degree, and the EGR opening degree is set to 0% which is the master opening degree. The flow velocity at that time is sonic in the throttle valve 6a and subsonic in the inlet valve 28. Further, the measurement item (intake amount) is the absolute flow rate. The specified item is the intake negative pressure.

In the purge opening degree correction in event (3), the throttle opening degree is set to equivalent to 7 deg which is the corrected opening degree, the intake opening degree is set to equivalent to 6 deg which is the corrected opening degree, the purge opening degree is set to 10% (including errors) which is the master opening degree, and the EGR opening degree is set to 0% which is the master opening degree. The flow velocity at that time is sonic in the throttle valve 6a, subsonic in the inlet valve 28, and subsonic in the purge valve 36. Furthermore, the measurement item (intake amount) is the change flow rate from event (2). The specified item is the intake negative pressure and the flow rate characteristic of the purge valve.

In the EGR opening degree in event (4), the throttle opening degree is set to equivalent to 7 deg which is the corrected opening degree, the intake opening degree is set to equivalent to 6 deg which is the corrected opening degree, the purge opening degree is set to 0% which is the master opening degree, and the EGR opening degree is set to 25% (including errors) which is the master opening degree. The flow velocity at that time is sonic in the throttle valve 6a, subsonic in the inlet valve 28, and subsonic in the EGR valve 23. Furthermore, the measurement item (intake amount) is the change flow rate from event (2). The specified item is the intake negative pressure and the flow rate characteristic of the EGR valve.

According to the control device of a supercharger-equipped engine in the present embodiment described above, the ECU 50 (the control unit) executes the foregoing fourth opening-degree variation correction control during operation of the engine 1. In this correction control, the ECU 50 controls the purge valve 36 and the EGR valve 23 to fully close and the inlet valve 28 to fully open, and further controls the electronic throttle device 6 to the master opening degree which is an arbitrary controlled opening degree so that the intake air passes through the electronic throttle device 6 at sonic velocity. At that time, the ECU 50 obtains the throttle actual opening degree TAR of the electronic throttle device 6 based on the intake amount Ga detected by the air flow meter 42 and the predetermined basic expression (F) representing the valve passing flow rate, learns the throttle opening degree correction value TAC of the electronic throttle device 6 from a difference between the obtained throttle actual opening degree TAR and the arbitrary master opening degree, and corrects the control of the electronic throttle device 6 based on the leant throttle opening degree correction value TAC.

After correcting the control of the electronic throttle device 6 based on the learnt throttle opening degree correction value TAC, the ECU 50 successively controls the purge valve 36 and the EGR valve 23 to fully close and controls the inlet valve 28 to close to the master opening degree corresponding to the arbitrary controlled opening degree. At that time, the ECU 50 obtains the intake actual opening degree ADR of the inlet valve 28 based on the intake amount Ga detected by the air flow meter 42 and the basic expression (F) representing the valve passing flow rate, learns the intake opening degree correction value ADC of the inlet valve 28 from a difference between the obtained intake actual opening degree ADR and the arbitrary master opening degree of the inlet valve 28, and corrects the control of the inlet valve 28 based on the learnt intake opening degree correction value ADC. According to the fourth opening-degree variation correction control, therefore, the control of the electronic throttle device 6 and the control of the inlet valve 28 are corrected without particular use of a dedicated pressure sensor for detecting the downstream pressure Pdn of the inlet valve 28. Thus, when the purge valve 36 is opened, the purge flow rate of purge gas allowed to flow in the intake passage 2 is corrected regardless of the presence/absence of the opening-degree variation of the inlet valve 28. Consequently, the purge flow rate can be accurately controlled without particular use of a dedicated pressure sensor regardless of the opening-degree variation of the inlet valve 28.

Furthermore, the ECU 50 successively corrects the control of the electronic throttle device 6 based on the learnt throttle opening degree correction value TAC and corrects the control of the inlet valve 28 based on the leant intake opening degree correction value ADC, and then controls the EGR valve 23 to fully close and obtains, as a purge flow-rate change rate, a change rate of the intake amount Ga detected by the air flow meter 42 when the purge valve 36 is controlled to a predetermined second opening degree (e.g., 10%) lager than a predetermined first opening degree (e.g., full close: 0%) with respect to the intake amount Ga detected by the air flow meter 42 when the purge valve 36 is controlled to the first opening degree. The ECU 50 further obtains a pressure difference between the upstream pressure and the downstream pressure of the purge valve 36 when the purge valve 36 is controlled to open to the second opening degree based on the foregoing basic expression (F) representing the valve passing flow rate. The ECU 50 obtains the purge actual opening degree PAR of the purge valve 36 based on the obtained purge flow-rate change rate and the pressure difference, learns the purge opening degree correction value PAC of the purge valve 36 from a difference between the obtained purge actual opening degree PAR and the second opening degree, and corrects the control of the purge valve 36 based on the learnt purge opening degree correction value PAC. According to this fourth opening-degree variation correction control, therefore, the control of the purge valve 36 is corrected without particular use of a dedicated pressure sensor for detecting the downstream pressure of the inlet valve 28. Thus, when the purge valve 36 is opened, the purge flow rate allowed to flow from the purge passage 35 into the intake passage 2 is corrected regardless of the presence/absence of the opening-degree variation of the purge valve 36. Consequently, the purge flow rate can be further accurately controlled without particular use of a dedicated pressure sensor regardless of the opening-degree variations of the inlet valve 28 and the purge valve 36.

In addition, the ECU 50 successively corrects the control of the electronic throttle device 6 based on the learnt throttle opening degree correction value TAC and corrects the control of the inlet valve 28 based on the leant intake opening degree correction value ADC, and then controls the EGR valve 36 to fully close and obtains, as an EGR gas flow-rate change rate, a change rate of the intake amount Ga detected by the air flow meter 42 when the purge valve 36 is controlled to fully close and controls the EGR valve 23 to open to a predetermined fourth opening degree (e.g., 25%) lager than a predetermined third opening degree (e.g., full close: 0%) with respect to the intake amount Ga detected by the air flow meter 42 when the EGR valve 23 is controlled to the third opening degree. The ECU 50 further obtains a pressure difference between the upstream pressure and the downstream pressure of the EGR valve 23 when the EGR valve 23 is controlled to open to the fourth opening degree based on the foregoing basic expression (F) representing the valve passing flow rate. The ECU 50 obtains the EGR actual opening degree EAR of the EGR valve 23 based on the obtained EGR gas flow-rate change rate and the pressure difference, learns the opening degree correction value (the EGR opening degree correction value EAC) of the EGR valve 23 from a difference between the obtained EGR actual opening degree EAR and the fourth opening degree, and corrects the control of the EGR valve 23 based on the learnt EGR opening degree correction value EAC. According to this fourth opening-degree variation correction control, therefore, the control of the EGR valve 23 is corrected without particular use of a dedicated pressure sensor for detecting the downstream pressure of the inlet valve 28. Thus, when the EGR valve 23 is opened, the EGR gas flow rate of EGR gas allowed to flow from the EGR passage 22 into the intake passage 2 is corrected regardless of the presence/absence of the opening-degree variation of the EGR valve 23. Consequently, the EGR gas flow rate can be accurately controlled without particular use of a dedicated pressure sensor regardless of the opening-degree variations of the inlet valve 28, the purge valve 36, and the EGR valve 23.

Specifically, according to the configuration in the present embodiment, a difference between each of the actual opening degrees (the throttle actual opening degree TAR, the intake actual opening degree ADR, the purge actual opening degree PAR, and the EGR actual opening degree EAR) of the electronic throttle device 6 (the throttle valve 6a), the inlet valve 28, the purge valve 36, and the EGR valve 23 and each corresponding predetermined various master opening degree is calculated based on the intake amount Ga detected by the air flow meter 42 and the basic expression (F) representing the valve passing flow rate, and the controls of various valves 6a, 28, 36, and 23 are corrected to a center of tolerance. Thus, variations in purge flow rate and EGR gas flow rate can be reduced.

### Fifth Embodiment

Next, a fifth embodiment that embodies the control device of a supercharger-equipped engine in a gasoline engine system will be described in detail with reference to accompanying drawings.

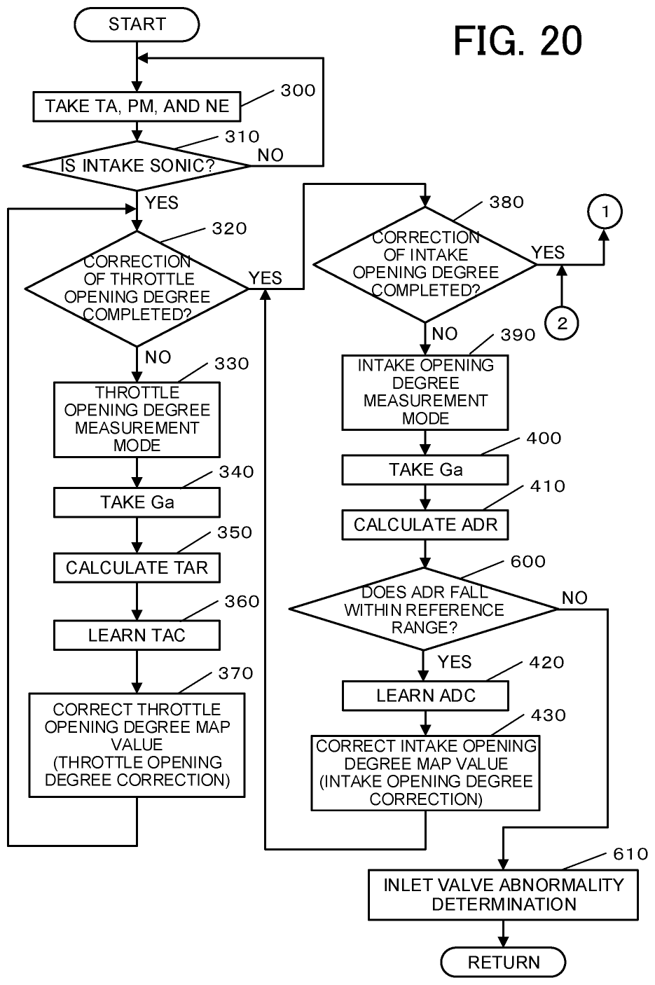

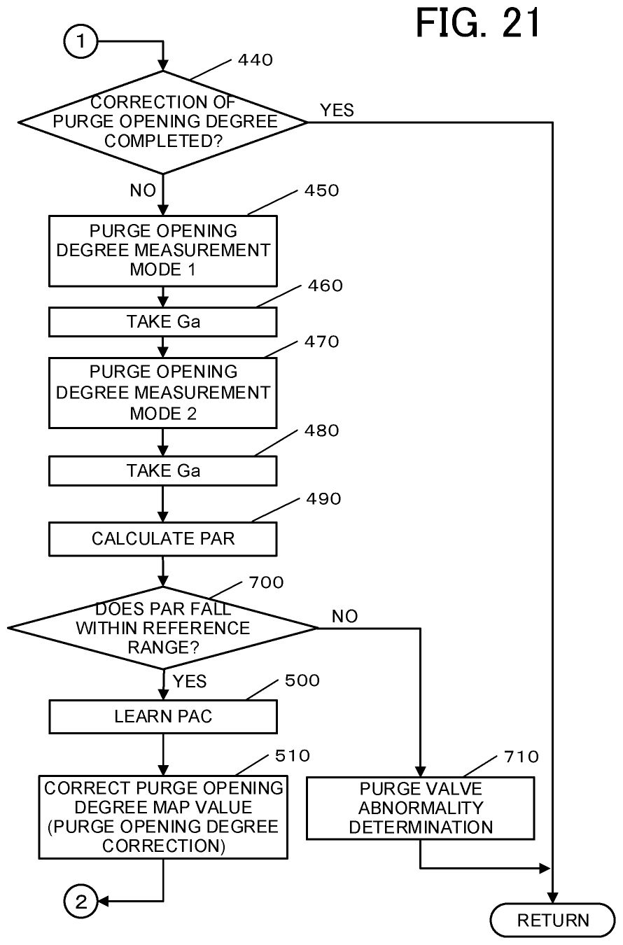

The present embodiment differs from the second embodiment in the contents of the opening-degree variation correction control. FIGS. 20 and 21 are flowcharts each showing contents of the fifth control to correct opening-degree variations (“fifth opening-degree variation correction control”) in the fifth embodiment. The flowcharts in FIGS. 20 and 21 differ from the flowchart (the contents of the second opening-degree variation correction control) in FIG. 4 in that the processings in step 600 and step 610 are added between step 410 and step 420, and the processings in step 700 and step 710 are added between step 490 and step 500.

(Fifth Opening-Degree Variation Correction Control)

The following description will be given to only differences from the contents of the second opening-degree variation correction control. In the present embodiment, after calculating the intake actual opening degree ADR in step 410, the ECU 50 determines in step 600 whether or not the intake actual opening degree ADR falls within a reference range. Herein, the reference range defines a normal opening degree range (a range from a lower-limit value to an upper-limit value) as the controlled opening degree of the inlet valve 28 and is defined depending on differences in configuration of the inlet valve 28. This reference range corresponds to one example of a “predetermined reference value for an opening degree of an inlet valve” in the present disclosure. When this determination result in step 600 is affirmative, indicating that the intake actual opening degree ADR falls within the reference range, the ECU 50 shifts the processing to step 420 and executes the processing in step 420 and subsequent steps. In contrast, when this determination result in step 600 is negative, indicating that the intake actual opening degree ADR does not fall within the reference range, the ECU 50 shifts the processing to step 610.

In step 610, the ECU 50 executes an inlet valve abnormality determination and terminates subsequent processings once. Herein, the ECU 50 can determine that the inlet valve 28 is abnormal in some way, store this determination result in a memory, and execute a predetermined informing control to warn a driver about the abnormality.

Herein, according to the above-described processings in steps 600 and 610, the ECU 50 is configured to compare the obtained actual opening degree (the intake actual opening degree ADR) of the inlet valve 28 and the predetermined reference value (the reference range) of the opening degree of the inlet valve 28 to diagnose the abnormality of the inlet valve 28. The configurations in steps 600 and 610 and steps 300 to 410 described above include the techniques recited in claim 7 and claim 11 of the present application.

After calculating the purge actual opening degree PAR in step 490, the ECU 50 further determines in step 700 whether or not the purge actual opening degree PAR falls within the reference range. Herein, the reference range defines a normal opening degree range (a range from a lower-limit value to an upper-limit value) as the controlled opening degree of the purge valve 36 and is defined depending on differences in configuration of the purge valve 36. This reference range corresponds to one example of a “predetermined reference value for an opening degree of a gas flow regulating valve” in the present disclosure. When this determination result in step 700 is affirmative, indicating that the purge actual opening degree PAR falls within the reference range, the ECU 50 shifts the processing to step 500 and executes the processings in step 500 and subsequent steps. In contrast, when this determination result in step 700 is negative, indicating that the purge actual opening degree PAR does not fall within the reference range, the ECU 50 shifts the processing to step 710.

In step 710, the ECU 50 executes a purge valve abnormality determination and terminates subsequent processings once. Herein, the ECU 50 can determine that the purge valve 36 is abnormal in some way, store this determination result in a memory, and execute a predetermined informing control to warn a driver about the abnormality.

Herein, according to the above-described processings in steps 700 and 710, the ECU 50 is configured to compare the obtained actual opening degree (the purge actual opening degree PAR) of the purge valve 36 and the predetermined reference value (the reference range) for the opening degree of the purge valve 36 to diagnose the abnormality of the purge valve 36. The configurations in steps 700 and 710 and steps 300 to 490 described above include the techniques recited in claim 8 and claim 12 of the present application.

Accordingly, the configuration in the present embodiment can provide the following operations and effects in addition to those in the second embodiment. Specifically, the actual opening degree of the inlet valve 28 (the intake actual opening degree ADR) is obtained based on the intake amount Ga detected by the air flow meter 42 when the electronic throttle device 6 is controlled to the arbitrary controlled opening degree so that the intake air passes through the electronic throttle device 6 at sonic velocity, and the abnormality of the inlet valve 28 is diagnosed based on the obtained intake actual opening degree ADR. Thus, there is no need to provide a dedicated pressure sensor other than the air flow meter 42 in order to diagnose the abnormality of the inlet valve 28. This configuration enables to diagnose the presence/absence of abnormality of the inlet valve 28 without using a dedicated pressure sensor.

Furthermore, according to the configuration in the present embodiment, the actual opening degree of the purge valve 36 (the purge actual opening degree PAR) is obtained based on the intake amount Ga detected by the air flow meter 42 when the electronic throttle device 6 is controlled to the arbitrary controlled opening degree so that the intake air passes through the electronic throttle device 6 at sonic velocity, and the abnormality of the purge valve 36 is diagnosed based on the obtained purge actual opening degree PAR. Thus, there is no need to provide a dedicated pressure sensor other than the air flow meter 42 in order to diagnose the abnormality of the purge valve 36. This configuration enables to diagnose the presence/absence of abnormality of the purge valve 36 without using a dedicated pressure sensor.

### Sixth Embodiment

Next, a sixth embodiment that embodies the control device of a supercharger-equipped engine in a gasoline engine system will be described in detail with reference to accompanying drawings.

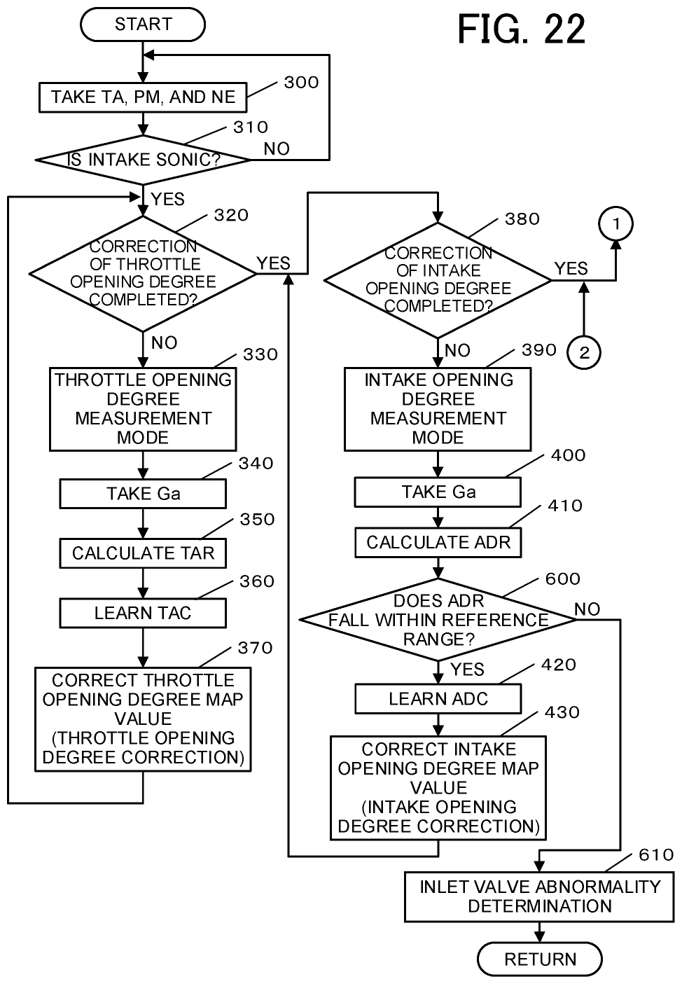

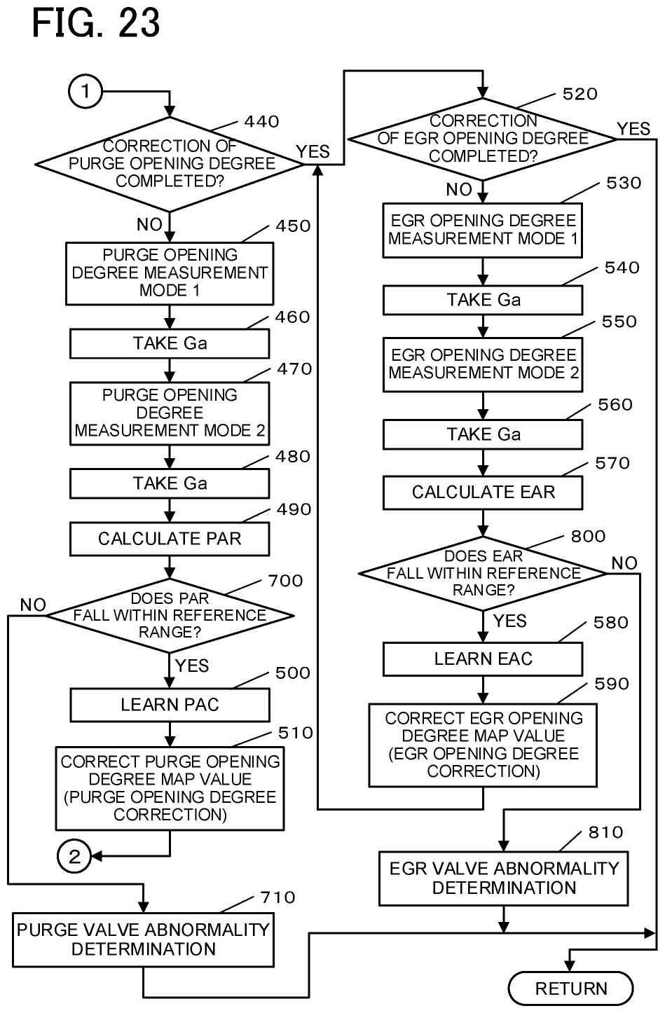

The present embodiment differs from the fourth embodiment in the contents of the opening-degree variation correction control. FIGS. 22 and 23 are flowcharts each showing contents of the sixth control to correct opening-degree variations (“sixth opening-degree variation correction control”) in the sixth embodiment. The flowcharts in FIGS. 22 and 23 differ from the flowcharts (the contents of the fourth opening-degree variation correction control) in FIGS. 13 and 14 in that the processings in step 600 and step 610 are added between step 410 and step 420, the processings in step 700 and step 710 are added between step 490 and step 500, and the processings in step 800 and step 810 are added between step 570 and step 580.

(Sixth Opening-Degree Variation Correction Control)

The following description will be given to only differences from the contents of the fourth opening-degree variation correction control. In the present embodiment, after calculating the intake actual opening degree ADR in step 410, the ECU 50 determines in step 600 whether or not the intake actual opening degree ADR falls within a reference range. Herein, the reference range defines a normal opening degree range (a range from a lower-limit value to an upper-limit value) as the controlled opening degree of the inlet valve 28 and is defined depending on differences in configuration of the inlet valve 28. This reference range corresponds to one example of the “predetermined reference value for an opening degree of an inlet valve” in the present disclosure. When this determination result in step 600 is affirmative, indicating that the intake actual opening degree ADR falls within the reference range, the ECU 50 shifts the processing to step 420 and executes the processing in step 420 and subsequent steps. In contrast, when this determination result in step 600 is negative, indicating that the intake actual opening degree ADR does not fall within the reference range, the ECU 50 shifts the processing to step 610.

In step 610, the ECU 50 executes an inlet valve abnormality determination and terminates subsequent processings once. Herein, the ECU 50 can determine that the inlet valve 28 is abnormal in some way, store this determination result in a memory, and execute a predetermined informing control to warn a driver about the abnormality.

Herein, according to the above-described processings in steps 600 and 610, the ECU 50 is configured to compare the obtained actual opening degree (the intake actual opening degree ADR) of the inlet valve 28 and the predetermined reference value (the reference range) for the opening degree of the inlet valve 28 to diagnose the abnormality of the inlet valve 28.

After calculating the purge actual opening degree PAR in step 490, the ECU 50 further determines in step 700 whether or not the purge actual opening degree PAR falls within the reference range. Herein, the reference range defines a normal opening degree range (a range from a lower-limit value to an upper-limit value) as the controlled opening degree of the purge valve 36 and is defined depending on differences in configuration of the purge valve 36. This reference range corresponds to one example of the “predetermined reference value for an opening degree of a gas flow regulating valve” in the present disclosure. When this determination result in step 700 is affirmative, indicating that the purge actual opening degree PAR falls within the reference range, the ECU 50 shifts the processing to step 500 and executes the processings in step 500 and subsequent steps. In contrast, when this determination result in step 700 is negative, indicating that the purge actual opening degree PAR does not fall within the reference range, the ECU 50 shifts the processing to step 710.

In step 710, the ECU 50 executes a purge valve abnormality determination and terminates subsequent processings once. Herein, the ECU 50 can determine that the purge valve 36 is abnormal in some way, store this determination result in a memory, and execute a predetermined informing control to warn a driver about the abnormality.

Herein, according to the above-described processings in steps 700 and 710, the ECU 50 is configured to compare the obtained actual opening degree (the purge actual opening degree PAR) of the purge valve 36 and the predetermined reference value (the reference range) for the opening degree of the purge valve 36 to diagnose the abnormality of the purge valve 36.

Furthermore, after calculating the EGR actual opening degree EAR in step 570, the ECU 50 further determines in step 800 whether or not the EGR actual opening degree EAR falls within the reference range. Herein, the reference range defines a normal opening degree range (a range from a lower-limit value to an upper-limit value) as the controlled opening degree of the EGR valve 23 and is defined depending on differences in configuration of the EGR valve 23. This reference range corresponds to one example of a “predetermined reference value for an opening degree of an EGR valve” in the present disclosure. When this determination result in step 800 is affirmative, indicating that the EGR actual opening degree EAR falls within the reference range, the ECU 50 shifts the processing to step 580 and executes the processing in step 580 and subsequent steps. In contrast, when this determination result in step 800 is negative, indicating that the EGR actual opening degree EAR does not fall within the reference range, the ECU 50 shifts the processing to step 810.

In step 810, the ECU 50 executes an EGR valve abnormality determination and terminates subsequent processings once. Herein, the ECU 50 can determine that the EGR valve 23 is abnormal in some way, store this determination result in a memory, and execute a predetermined informing control to warn a driver about the abnormality.

Herein, according to the above-described processings in steps 800 and 810, the ECU 50 is configured to compare the obtained actual opening degree (the EGR actual opening degree EAR) of the EGR valve 23 and the predetermined reference value (the reference range) for the opening degree of the EGR valve 23 to diagnose the abnormality of the EGR valve 23.

Accordingly, the configuration in the present embodiment can provide the following operations and effects in addition to those in the fourth embodiment. Specifically, the actual opening degree of the inlet valve 28 (the intake actual opening degree ADR) is obtained based on the intake amount Ga detected by the air flow meter 42 when the electronic throttle device 6 is controlled to the arbitrary controlled opening degree so that the intake air passes through the electronic throttle device 6 at sonic velocity, and the abnormality of the inlet valve 28 is diagnosed based on the obtained intake actual opening degree ADR. Thus, there is no need to provide a dedicated pressure sensor other than the air flow meter 42 in order to diagnose the abnormality of the inlet valve 28. This configuration enables to diagnose the presence/absence of abnormality of the inlet valve 28 without using a dedicated pressure sensor.

Furthermore, according to the configuration in the present embodiment, the actual opening degree of the purge valve 36 (the purge actual opening degree PAR) is obtained based on the intake amount Ga detected by the air flow meter 42 when the electronic throttle device 6 is controlled to the arbitrary controlled opening degree so that the intake air passes through the electronic throttle device 6 at sonic velocity, and the abnormality of the purge valve 36 is diagnosed based on the obtained purge actual opening degree PAR. Thus, there is no need to provide a dedicated pressure sensor other than the air flow meter 42 in order to diagnose the abnormality of the purge valve 36. This configuration enables to diagnose the presence/absence of abnormality of the purge valve 36 without using a dedicated pressure sensor.

Still further, in the configuration in the present embodiment, the actual opening degree of the EGR valve 23 (the EGR actual opening degree EAR) is obtained based on the intake amount Ga detected by the air flow meter 42 when the electronic throttle device 6 is controlled to the arbitrary controlled opening degree so that the intake air passes through the electronic throttle device 6 at sonic velocity, and the abnormality of the EGR valve 23 is diagnosed based on the obtained EGR actual opening degree EAR. Thus, there is no need to provide a dedicated pressure sensor other than the air flow meter 42 in order to diagnose the abnormality of the EGR valve 23. This configuration enables to diagnose the presence/absence of abnormality of the EGR valve 23 without using a dedicated pressure sensor.

### Seventh Embodiment

Next, a seventh embodiment that embodies the control device of a supercharger-equipped engine in a gasoline engine system will be described in detail with reference to accompanying drawings.

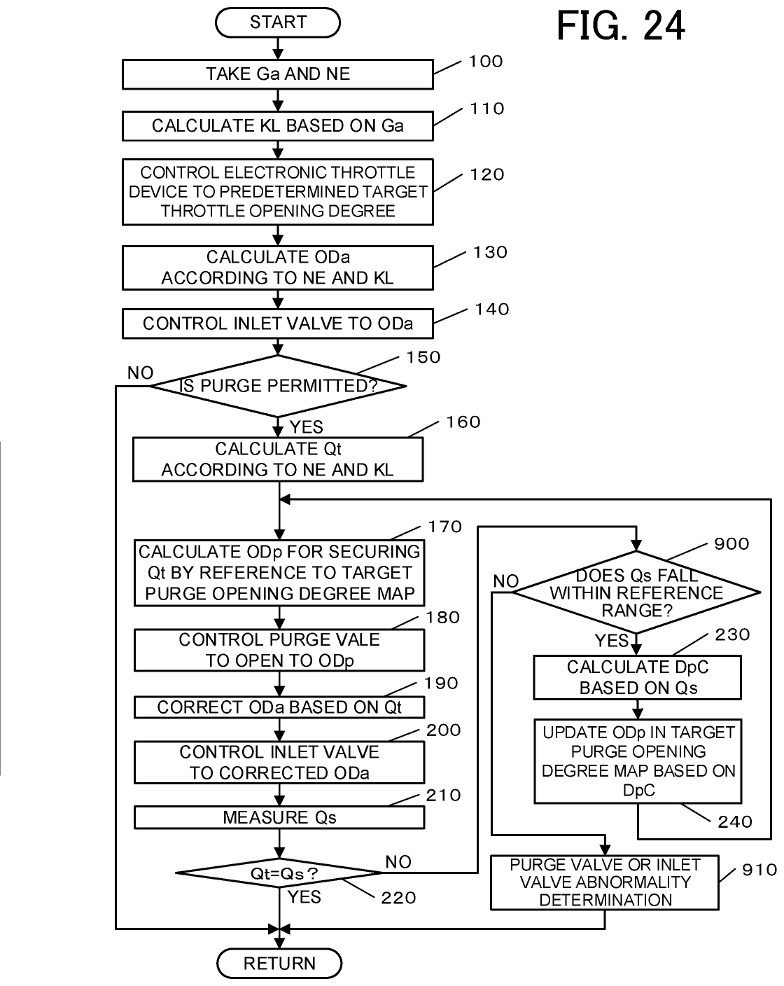

The present embodiment differs from the first embodiment in the contents of the opening-degree variation correction control. FIG. 24 is a flowchart showing the contents of the seventh control to correct opening-degree variations (“seventh opening-degree variation correction control”) in the present embodiment. The flowchart in FIG. 24 differs from the flowchart (the contents of the first opening-degree variation correction control) in FIG. 2 in that the processings in step 900 and 910 are added between the step 220 and step 230.

(Seventh Opening-Degree Variation Correction Control)

The following description will be given to only differences from the contents of the first opening-degree variation correction control. In the present embodiment, when the determination result in step 220 is negative, the ECU 50 determines in step 900 whether or not the actual purge flow rate Qs falls within a reference range. Herein, the reference range defines a normal flow rate range (a range from a lower-limit value to an upper-limit value) as the actual purge flow rate Qs and is defined depending on differences in configuration of the purge valve 36 or the inlet valve 28. This reference range corresponds to one example of a predetermined reference value in the present disclosure. When this determination result in step 900 is affirmative, indicating that the actual purge flow rate Qs falls within the reference range, the ECU 50 shifts the processing to step 230 and executes the processing in step 230 and subsequent steps. In contrast, when this determination result in step 900 is negative, indicating that the actual purge flow rate Qs does not fall within the reference range, the ECU 50 shifts the processing to step 910.

In step 910, the ECU 50 executes a purge valve or inlet valve abnormality determination and terminates subsequent processings once. Herein, the ECU 50 can determine that the purge valve 36 or the inlet valve 28 is abnormal in some way, store this determination result in a memory, and execute a predetermined informing control to warn a driver about the abnormality.

Herein, according to the above-described processings in steps 900 and 910, the ECU 50 is configured to compare the obtained actual gas flow rate (the actual purge flow rate Qs) measured based on the intake amount Ga detected by the air flow meter 42 with the predetermined reference value (the reference range) to diagnose the abnormality of the purge valve 36 or the inlet valve 28. The configurations in steps 900 and 910 and steps 100 to 240 described above include the techniques recited in claim 9 and claim 10 of the present application.

Accordingly, the configuration in the present embodiment can provide the following operations and effects in addition to those in the first embodiment. Specifically, the abnormality of the purge valve 36 or the abnormality of the inlet valve 28 is diagnosed based on the actual purge flow rate Qs measured based on the intake amount Ga detected by the air flow meter 42. Thus, there is no need to provide a dedicated pressure sensor other than the air flow meter 42 in order to diagnose the abnormality of the purge valve 36 or the abnormality of the inlet valve 28. This configuration enables to diagnose the presence/absence of abnormality of the purge valve 36 or the inlet valve 28 without using a dedicated pressure sensor.

The present disclosure is not limited to each of the foregoing embodiments and may be partially embodied in other specific forms without departing from the essential characteristics thereof.

(1) The first embodiment is configured to execute only the first opening-degree variation correction control; the second embodiment is configured to execute only the second opening-degree variation correction control; the fifth embodiment is configured to execute only the fifth opening-degree variation correction control; and the seventh embodiment is configured to execute only the seventh opening-degree variation correction control. As an alternative, it may be arranged to execute both of (i) the first opening-degree variation correction control or the seventh opening-degree variation correction control and (ii) the second opening-degree variation correction control or the fifth opening-degree variation correction control in a single engine system. This configuration enables to more accurately control the purge flow rate allowed to flow in the intake passage 2.

(2) The first embodiment is configured to execute only the first opening-degree variation correction control; the second embodiment is configured to execute only the second opening-degree variation correction control; the fifth embodiment is configured to execute only the fifth opening-degree variation correction control; and the seventh embodiment is configured to execute only the seventh opening-degree variation correction control. As an alternative, it may be arranged to execute the second opening-degree variation correction control or the fifth opening-degree variation correction control instead of the processings in step 230 and step 240 in FIGS. 2 and 24 in the first opening-degree variation correction control or the seventh opening-degree variation correction control. This configuration can also address relatively long-span variations such as deterioration with time in the engine system and further variations in running environment (e.g., variations in atmospheric pressure during hill-climbing or hill-descending) which may occur relatively often.

(3) The third embodiment is configured to execute only the third opening-degree variation correction control; the fourth embodiment is configured to execute only the fourth opening-degree variation correction control; and the sixth embodiment is configured to execute only the sixth opening-degree variation correction control. As an alternative, it may be arranged to execute both of (i) the third opening-degree variation correction control and (ii) the fourth opening-degree variation correction control or the sixth opening-degree variation correction control in a single engine system. This configuration enables to more accurately control the purge flow rate and the EGR gas flow rate allowed to flow in the intake passage 2.

(4) The third embodiment is configured to execute only the third opening-degree variation correction control; the fourth embodiment is configured to execute only the fourth opening-degree variation correction control; and the sixth embodiment is configured to execute only the sixth opening-degree variation correction control. As an alternative, it may be arranged to execute the fourth opening-degree variation correction control or the sixth opening-degree variation correction control instead of the processings in step 230 and step 240 in FIG. 12 in the third opening-degree variation correction control. This configuration can also address relatively long-span variations such as deterioration with time in the engine system and further variations in running environment (e.g., variations in atmospheric pressure during hill-climbing or hill-descending) which may occur relatively often.

(5) The first embodiment, the third embodiment, and the seventh embodiment are configured to calculate the purge opening degree correction value

DpC for the purge valve 36 based on the actual purge flow rate Qs in step 230 and step 240 shown in FIGS. 2, 12, and 24, and update (correct) the target purge opening degree ODp in the target purge opening degree map based on the calculated purge opening degree correction value DpC. As an alternative, instead of step 230 and step 240 shown in FIGS. 2, 12, and 24, it may be arranged to calculate an intake opening degree correction value for an inlet valve based on the actual purge flow rate Qs (the actual gas flow rate), and update (correct) a target intake opening degree of the inlet valve based on the calculated intake opening degree correction value.

(6) The first embodiment or the seventh embodiment is provided with the purge passage 35 serving as the gas passage for flowing vapor and the purge valve 36 serving as the gas flow rate control valve in the first opening-degree variation correction control or the seventh opening-degree variation correction control. As an alternative, an EGR passage for flowing EGR gas as the gas passage and an EGR valve as the gas flow rate control valve may be provided, and a blowby gas ventilation passage for flowing blowby gas as the gas passage and a blowby gas flow rate control valve as the gas flow rate control valve may be provided.

(7) The second embodiment or the fifth embodiment is configured to execute the throttle opening degree correction, the intake opening degree correction, and the purge opening degree correction in the second opening-degree variation correction control or the fifth opening-degree variation correction control. As an alternative, in the second opening-degree variation correction control or the fifth opening-degree variation correction control, the purge opening degree correction may be omitted and only the throttle opening degree correction and the intake opening degree correction may be executed.

(8) The second embodiment or the fifth embodiment is configured to execute the throttle opening degree correction, the intake opening degree correction, and the purge opening degree correction in the second opening-degree variation correction control or the fifth opening-degree variation correction control. As an alternative, in the second opening-degree variation correction control or the fifth opening-degree variation correction control, it may be arranged to execute correction of an EGR opening degree map value of the EGR valve (EGR opening degree correction) instead of the purge opening degree correction and to execute correction of a blowby gas flow rate opening degree map value of the blowby gas flow rate control valve (blowby gas flow rate opening degree correction).

(9) The second embodiment or the fifth embodiment is configured to sequentially execute the throttle opening degree correction, the intake opening degree correction, and the purge opening degree correction as a series of events (1) to (3). These throttle opening degree correction, intake opening degree correction, and purge opening degree correction may be executed separately at different timings.

(10) The fourth embodiment or the sixth embodiment is configured to sequentially execute the throttle opening degree correction, the intake opening degree correction, the purge opening degree correction, and the EGR opening degree correction as a series of events (1) to (4). These throttle opening degree correction, intake opening degree correction, purge opening degree correction, and EGR opening degree correction may be executed separately at different timings.

(11) In each of the above-described embodiments, a purge pump for delivering vapor under pressure to the intake passage 2 is not provided in the atmosphere port 33a of the canister 33 or in the purge passage 35; however, this purge pump may be provided therein.

(12) In each of the above-described embodiments, in a normal gasoline engine vehicle, the first to fourth opening-degree variation correction controls are executed when the intake air passes through the electronic throttle device 6 (the throttle valve 6a) at sonic velocity. As an alternative, in the normal gasoline engine vehicle and a motor-equipped hybrid vehicle, the first to fourth opening-degree variation correction controls may be executed when intake air passes through an electronic throttle device at sonic velocity. For instance, in the normal gasoline engine vehicle and a parallel or split hybrid vehicle, the first to fourth opening-degree variation correction controls may be executed when an engine is in steady running and the intake air passes through an electronic throttle device at sonic velocity. Alternatively, in a series hybrid vehicle, the first to fourth opening-degree variation correction controls may be executed when the intake air passes through an electronic throttle device at sonic velocity. Herein, the “parallel” mode is a mode in which both an engine and a motor are used for driving wheels. The “split” mode is a mode in which power from an engine is split by a power splitting mechanism and distributed into a power generator and wheels or in which power from an engine and power of a motor are appropriately combined. The “series” mode is a mode in which an engine is used only to generate electric power, use the motor only to drive a wheel axis and regenerate, and additionally include a rechargeable battery for recovering electric power. That is, the series hybrid vehicle is an electric car mounted with an engine as a power source for power generation.

(Additional Techniques)

The foregoing fourth embodiment and the sixth embodiment include the following additional technique 1 depending on claim 3, as mentioned below. The operations and effects of this additional technique 1 are described in the fourth and sixth embodiments.

(Additional Technique 1)

In a control device of a supercharger-equipped engine as set forth in claim 3,

the control unit is configured to:
when controlling the gas flow regulating valve and the EGR valve to fully close, controlling the inlet valve to fully open, and further controlling the intake amount regulating valve to an arbitrary controlled opening degree so that intake air passes through the intake amount regulating valve at sonic velocity,
obtain an actual opening degree of the intake amount regulating valve based on the intake amount of detected by the intake amount detecting unit and a predetermined basic expression;
learn an opening degree correction value of the intake amount regulating valve from a difference between the obtained actual opening degree and the controlled opening degree; and
correct control of the intake amount regulating valve based on the learnt opening degree correction value,

the control unit is configured to:
after correcting the control of the intake amount regulating valve based on the leant opening degree correction value of the intake amount regulating valve,
when controlling the gas flow regulating valve and the EGR valve to fully close and controlling the inlet valve to close to the arbitrary controlled opening degree,
obtain an actual opening degree of the inlet valve based on the intake amount detected by the intake amount detecting unit and the basic expression;
learn an opening degree correction value of the inlet valve from a difference between the obtained actual opening degree and the controlled opening degree of the inlet valve; and
correct the control of the inlet valve based on the learnt opening degree correction value,

the control unit is configured to:
after correcting the control of the intake amount regulating valve based on the learnt opening degree correction value of the intake amount regulating valve and correcting the control of the inlet valve based on the leant opening degree correction value of the inlet valve,
control the EGR valve to fully close;
obtain, as a gas flow rate change rate, a change rate of the intake amount detected by the intake amount detecting unit when the gas flow regulating valve is controlled to a predetermined second opening degree larger than a predetermined first opening degree with respect to the intake amount detected by the intake amount detecting unit when the gas flow regulating valve is controlled to a predetermined first opening degree;
obtain an actual opening degree of the gas flow regulating valve based on the obtained gas flow rate change rate and the basic expression;
learn an opening degree correction value of the gas flow regulating valve from a difference between the obtained actual opening degree and the second opening degree of the gas flow regulating valve; and
correct the control of the gas flow regulating valve based on the leant opening degree correction value,

the control unit is configured to:
after correcting the control of the intake amount regulating valve based on the leant opening degree correction value of the intake amount regulating valve and correcting the control of the inlet valve based on the leant opening degree correction value of the inlet valve,
control the gas flow regulating valve to fully close;
obtain, as an EGR gas flow-rate change rate, a change rate of the intake amount detected by the intake amount detecting unit when the EGR valve is controlled to a predetermined fourth opening degree larger than a predetermined third opening degree with respect to the intake amount detected by the intake amount detecting unit when the gas flow regulating valve is controlled to fully close and the EGR valve is controlled to the third opening degree;
obtain an actual opening degree of the EGR valve based on the obtained EGR gas flow-rate change rate and the basic expression;
learn an opening degree correction value of the EGR valve from a difference between the obtained actual opening degree and the fourth opening degree; and
correct control of the EGR valve based on the learnt opening degree correction value.

The foregoing sixth embodiment includes the following additional technique 2 depending on the above-described additional technique 1 as mentioned below. The operations and effects of this additional technique 2 are described in the sixth embodiment.

(Additional Technique 2)

In the control device of a supercharger-equipped engine as set forth in additional technique 1,

the control unit is configured to compare the obtained actual opening degree of the EGR valve with a predetermined reference value for an opening degree of the EGR valve to diagnose abnormality of the EGR valve.

### INDUSTRIAL APPLICABILITY

The present disclosure is utilizable in a supercharger-equipped engine.

### REFERENCE SIGNS LIST

1 Engine
2 Intake passage
3 Exhaust passage
5 Supercharger
5a Compressor
5b Turbine
5c Rotary shaft
6 Electronic throttle device (Intake amount regulating valve)
6a Throttle valve
21 EGR device
22 EGR passage
22a Inlet
22b Outlet
23 EGR valve
28 Intake valve
31 Evaporated fuel treatment device
32 Fuel tank
33 Canister
35 Purge passage (Gas passage)
35a Inlet
35b Outlet
36 Purge valve (Gas flow regulating valve)
42 Air flow meter (Intake amount detecting unit)
50 ECU (Control unit)

1. A control device of a supercharger-quipped engine, the engine comprising:
a supercharger provided in an intake passage and an exhaust passage of the engine and configured to increase pressure of intake air in the intake passage,
the supercharger including a compressor placed in the intake passage, a turbine placed in the exhaust passage, and a rotary shaft connecting the compressor and the turbine to cause the compressor and the turbine to integrally rotate;
an intake amount regulating valve provided in the intake passage downstream from the compressor and configured to have an adjustable opening degree to regulate an intake amount of air flowing through the intake passage;
a gas passage connected to the intake passage upstream from the compressor and configured to supply a predetermined gas to the intake passage;
a gas flow regulating valve provided in the gas passage and configured to have an adjustable opening degree to regulate a gas flow rate in the gas passage;
an inlet valve provided in the intake passage upstream from a junction of the gas passage with the intake passage and configured to have an adjustable opening degree to restrict the intake amount of air to be sucked in the intake passage;
an intake flow detecting unit configured to detect the intake amount of air flowing through the intake passage upstream from the inlet valve; and
a control unit configured to control at least the intake amount regulating valve, the gas flow regulating valve, and the inlet valve,
wherein the control unit is configured to:
while controlling the intake amount regulating valve to a predetermined opening degree and controlling the inlet valve to a target intake opening degree according to an operating state of the engine,
calculate a target gas flow rate to be supplied to the intake passage according to the operating state of the engine;
calculate a target gas flow rate opening degree for securing the target gas flow rate based on predetermined function data;
control the gas flow regulating valve to the target gas flow rate opening degree;
correct the target intake opening degree based on the target gas flow rate; and
control the inlet valve based on the corrected target intake opening degree.

2. The control device of a supercharger-quipped engine according to claim 1, wherein the control unit is configured to:
measure an actual gas flow rate to be supplied from the gas passage to the intake passage based on the intake amount detected by the intake flow detecting unit;
calculate an opening degree correction value of the gas flow regulating valve or the inlet valve based on the measured actual gas flow rate so that the actual gas flow rate becomes equal to the target gas flow rate; and
update the target gas flow rate opening degree in the function data based on the calculated opening degree correction value or update the target intake opening degree of the inlet valve.

3. The control device of a supercharger-quipped engine according to claim 1, further comprising:
an EGR passage configured to allow a part of exhaust gas discharged from the engine to the exhaust passage to flow as EGR gas into the intake passage to return to the engine,
the EGR passage including an inlet connected to the exhaust passage downstream from the turbine and an outlet connected to the intake passage upstream from the compressor and downstream from the inlet valve; and
an EGR valve configured to have an adjustable opening degree to regulate an EGR gas flow rate in the EGR passage,
wherein the control unit is configured to control at least the intake amount regulating valve, the gas flow regulating valve, the inlet valve, and the EGR valve, and
the control unit is configured to:
while controlling the intake amount regulating valve to the predetermined opening degree and controlling the inlet valve to the target intake opening degree according to the operating state of the engine, and further controlling the EGR valve to a target EGR opening degree according to the operating state of the engine,
calculate the target gas flow rate to be supplied to the intake passage according to the operating state of the engine;
calculate the target gas flow rate opening degree for securing the target gas flow rate based on the predetermined function data;
control the gas flow regulating valve to the target gas flow rate opening degree;
correct the target intake opening degree based on the target gas flow rate; and
control the inlet valve based on the corrected target intake opening degree.

4. The control device of a supercharger-quipped engine according to claim 1, wherein
the control unit is configured to:
when controlling the gas flow regulating valve to fully close, controlling the inlet valve to fully open, and further controlling the intake amount regulating valve to an arbitrary controlled opening degree so that intake air passes through the intake amount regulating valve at sonic velocity,
obtain an actual opening degree of the intake amount regulating valve based on the intake amount detected by the intake flow detecting unit and a predetermined basic expression;
learn an opening degree correction value of the intake amount regulating valve from a difference between the obtained actual opening degree and the controlled opening degree; and
correct control of the intake amount regulating valve based on the learnt opening degree correction value; and
the control unit is configured to:
after correcting the control of the intake amount regulating valve based on the learnt opening degree correction value of the intake amount regulating valve,
when controlling the gas flow regulating valve to fully close and controlling the inlet valve to close to the arbitrary controlled opening degree,
obtain an actual opening degree of the inlet valve based on the intake amount detected by the intake flow detecting unit and the basic expression;
learn an opening degree correction value of the inlet valve from a difference between the obtained actual opening degree and the controlled opening degree of the inlet valve; and
correct control of the inlet valve based on learnt opening degree correction value.

5. A control device of a supercharger-quipped engine, the engine comprising:
a supercharger provided in an intake passage and an exhaust passage of the engine and configured to increase pressure of intake air in the intake passage,
the supercharger including a compressor placed in the intake passage, a turbine placed in the exhaust passage, and a rotary shaft connecting the compressor and the turbine to cause the compressor and the turbine to integrally rotate;
an intake amount regulating valve provided in the intake passage downstream from the compressor and configured to have an adjustable opening degree to regulate an intake amount of air flowing through the intake passage;
an evaporated fuel treatment device configured to collect evaporated fuel generated in a fuel tank into a canister once and purge the evaporated fuel to the intake passage through a purge passage provided with a purge valve configured to have an adjustable opening degree,
the purge passage including an inlet connected to the canister and an outlet connected to the intake passage upstream from the compressor;
an inlet valve provided in the intake passage upstream from the outlet of the purge passage and configured to have an adjustable opening degree to restrict the intake amount of air to be sucked into the intake passage;
an intake flow detecting unit configured to detect the intake amount of air flowing through the intake passage upstream from the inlet valve; and
a control unit configured to control at least the intake amount regulating valve, the purge valve, and the inlet valve,
wherein the control unit is configured to:
when controlling the purge valve to fully close, controlling the inlet valve to fully open, and further controlling the intake amount regulating valve to an arbitrary controlled opening degree so that intake air passes through the intake amount regulating valve at sonic velocity,
obtain an actual opening degree of the intake amount regulating valve based on the intake amount detected by the intake flow detecting unit and a predetermined basic expression;
learn an opening degree correction value of the intake amount regulating valve from a difference between the obtained actual opening degree and the controlled opening degree; and
correct control of the intake amount regulating valve based on the learnt opening degree correction value, and
the control unit is configured to:
after correcting the control of the intake amount regulating valve based on the learnt opening degree correction value of the intake amount regulating valve,
when controlling the purge valve to fully close and controlling the inlet valve to close to the arbitrary controlled opening degree;
obtain an actual opening degree of the inlet valve based on the intake amount detected by the intake flow detecting unit and the basic expression;
learn an opening degree correction value of the inlet valve from a difference between the obtained actual opening degree and the controlled opening degree of the inlet valve; and
correct control of the inlet valve based on the learnt opening degree correction value.

6. The control device of a supercharger-quipped engine according to claim 4, wherein the control unit is configured to:
after correcting the control of the intake amount regulating valve based on the learnt opening degree correction value of the intake amount regulating valve and correcting the control of the inlet valve based on the learnt opening degree correction value of the inlet valve,
obtain, as a gas flow rate change rate, a change rate of the intake amount detected by the intake flow detecting unit when the gas flow regulating valve is controlled to a predetermined second opening degree larger than a predetermined first opening degree, with respect to the intake amount detected by the intake flow detecting unit when the gas flow regulating valve is controlled to the first opening degree;
obtain an actual opening degree of the gas flow regulating valve based on the gas flow rate change rate and the basic expression;
learn an opening degree correction value of the gas flow regulating valve from a difference between the obtained actual opening degree and the second opening degree of the gas flow regulating valve; and
correct control of the gas flow regulating valve based on the learnt opening degree correction value.

7. The control device of a supercharger-quipped engine according to claim 4, wherein the control unit is configured to compare the obtained actual opening degree of the inlet valve with a predetermined reference value for an opening degree of the inlet valve to diagnose abnormality of the inlet valve.

8. The control device of a supercharger-quipped engine according to claim 6, wherein the control unit is configured to compare the obtained actual opening degree of the gas flow regulating valve with a predetermined reference value for an opening degree of the gas flow regulating valve to diagnose abnormality of the gas flow regulating valve.

9. The control device of a supercharger-quipped engine according to claim 2, wherein the control unit is configured to compare the actual gas flow rate measured based on the intake amount detected by the intake flow detecting unit with a predetermined reference value to diagnose abnormality of the gas flow regulating valve or abnormality of the inlet valve.

10. The control device of a supercharger-quipped engine according to claim 1, wherein the control unit is configured to:
measure an actual gas flow rate to be supplied from the gas passage to the intake passage based on the intake amount detected by the intake flow detecting unit; and
compare the measured actual gas flow rate with a predetermined reference value to diagnose abnormality of the gas flow regulating valve or abnormality of the inlet valve.

11. The control device of a supercharger-quipped engine according to claim 1, wherein
the control unit is configured to:
when controlling the gas flow regulating valve to fully close, controlling the inlet valve to fully open, and further controlling the intake amount regulating valve to an arbitrary controlled opening degree so that intake air passes through the intake amount regulating valve at sonic velocity,
obtain an actual opening degree of the intake amount regulating valve based on the intake amount detected by the intake flow detecting unit and a predetermined basic expression;
learn an opening degree correction value of the intake amount regulating valve from a difference between the obtained actual opening degree and the controlled opening degree; and
correct control of the intake amount regulating valve based on the learnt opening degree correction value; and
the control unit is configured to:
after correcting the control of the intake amount regulating valve based on the learnt opening degree correction value of the intake amount regulating valve,
when controlling the gas flow regulating valve to fully close and controlling the inlet valve to close to the arbitrary controlled opening degree,
obtain an actual opening degree of the inlet valve based on the intake amount detected by the intake flow detecting unit and the basic expression; and
compare the obtained actual opening degree of the inlet valve with a predetermined reference value for the opening degree of the inlet valve to diagnose abnormality of the inlet valve.

12. The control device of a supercharger-quipped engine according to claim 4, wherein the control unit is configured to:
after correcting the control of the intake amount regulating valve based on the learnt opening degree correction value of the intake amount regulating valve and correcting the control of the inlet valve based on the learnt opening degree correction value of the inlet valve,
obtain, as a gas flow rate change rate, a change rate of the intake amount detected by the intake flow detecting unit when the gas flow regulating valve is controlled to a predetermined second opening degree larger than a predetermined first opening degree, with respect to the intake amount detected by the intake flow detecting unit when the gas flow regulating valve is controlled to the first opening degree;
obtain an actual opening degree of the gas flow regulating valve based on the gas flow rate change rate and the basic expression; and
compare the obtained actual opening degree of the gas flow regulating valve with a predetermined reference value for the opening degree of the gas flow regulating valve to diagnose abnormality of the gas flow regulating valve.

13. The control device of a supercharger-quipped engine according to claim 5, wherein the control unit is configured to compare the obtained actual opening degree of the inlet valve with a predetermined reference value for an opening degree of the inlet valve to diagnose abnormality of the inlet valve.
